(19) United States
(12) Patent Application Publication
(10) Pub. No.: US 2008/0111855 A1
(43) Pub. Date: May 15, 2008

(54) PRINTHEAD PROVIDED WITH INDIVIDUAL NOZZLE ENCLOSURES

(75) Inventors: Kia Silverbrook, Balmain (AU); Gregory John McAvoy, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/015,218

(22) Filed: Jan. 16, 2008

Related U.S. Application Data
(63) Continuation of application No. 11/084,237, filed on Mar. 21, 2005, now Pat. No. 7,331,651.

(51) Int. Cl. B41J 2/14

(52) U.S. Cl. 347/47

(57) ABSTRACT

A printhead comprising a plurality of unit cells, at least one of the plurality of unit cells comprising a substrate including an ink inlet passage. A chamber is defined by chamber sidewalls and at least part of a nozzle plate defining an aperture for ejection of ink from the chamber, the chamber being in fluid communication with the inlet passage. A nozzle enclosure comprising enclosure sidewalls and a roof defining an opening for ejection of ink, the nozzle enclosure surrounding the aperture. Ink ejected from the aperture is directed to the opening of the nozzle enclosure, thereby isolating the aperture from an adjacent aperture of an adjacent unit cell.

### CROSS REFERENCE TO RELATED APPLICATION

This application is a continuation application of U.S. patent application Ser. No. 11/084,237 filed on Mar. 21, 2005 all of which are herein incorporated by reference.

### CO-PENDING APPLICATIONS

The following applications have been filed by the Applicant simultaneously with the present application:

Ser. Nos. 11/084,237 11/084,240

The disclosures of these co-pending applications are incorporated herein by reference.

### CROSS REFERENCES TO RELATED APPLICATIONS

The following patents or patent applications filed by the applicant or assignee of the present invention are hereby incorporated by cross-reference.

| | | | | | |
|---|---|---|---|---|---|
| 6750901 | 6476863 | 6788336 | 6322181 | 11/003786 | 11/003616 |
| 11/003418 | 11/003334 | 11/003600 | 11/003404 | 11/003419 | 11/003700 |
| 11/003601 | 11/003618 | 7229148 | 11/003337 | 11/003698 | 11/003420 |
| 6984017 | 11/003699 | 11/003463 | 11/003701 | 11/003683 | 11/003614 |
| 11/003702 | 11/003684 | 11/003619 | 11/003617 | 6623101 | 6406129 |
| 6505916 | 6457809 | 6550895 | 6457812 | 7152962 | 6428133 |
| 7204941 | 10/815624 | 10/815628 | 10/913375 | 10/913373 | 10/913374 |
| 10/913372 | 7138391 | 7153956 | 10/913380 | 10/913379 | 10/913376 |
| 7122076 | 7148345 | 10/407212 | 10/407207 | 10/683064 | 10/683041 |
| 10/882774 | 10/884889 | 10/922890 | 10/922875 | 10/922885 | 10/922889 |
| 10/922884 | 10/922879 | 10/922887 | 10/922888 | 10/922874 | 7234795 |
| 10/922871 | 10/922880 | 10/922881 | 10/922882 | 10/922883 | 10/922878 |
| 10/922872 | 10/922876 | 10/922886 | 10/922877 | 6746105 | 7156508 |
| 7159972 | 7083271 | 7165834 | 7080894 | 7201469 | 7090336 |
| 7156489 | 10/760233 | 10/760246 | 7083257 | 10/760243 | 10/760201 |
| 7219980 | 10/760253 | 10/760255 | 10/760209 | 7118192 | 10/760194 |
| 10/760238 | 7077505 | 7198354 | 7077504 | 10/760189 | 7198355 |
| 10/760232 | 10/760231 | 7152959 | 7213906 | 7178901 | 7222938 |
| 7108353 | 7104629 | 10/728804 | 7128400 | 7108355 | 6991322 |
| 10/728790 | 7118197 | 10/728970 | 10/728784 | 10/728783 | 7077493 |
| 6962402 | 10/728803 | 7147308 | 10/728779 | 7118198 | 7168790 |
| 7172270 | 7229155 | 6830318 | 7195342 | 7175261 | 10/773183 |
| 7108356 | 7118202 | 10/773186 | 7134744 | 10/773185 | 7134743 |
| 7182439 | 7210768 | 10/773187 | 7134745 | 7156484 | 7118201 |
| 7111926 | 10/773184 | 09/575197 | 7079712 | 09/575123 | 6825945 |
| 09/575165 | 6813039 | 6987506 | 7038797 | 6980318 | 6816274 |
| 7102772 | 09/575186 | 6681045 | 6728000 | 7173722 | 7088459 |
| 09/575181 | 7068382 | 7062651 | 6789194 | 6789191 | 6644642 |
| 6502614 | 6622999 | 6669385 | 6549935 | 6987573 | 6727996 |
| 6591884 | 6439706 | 6760119 | 09/575198 | 7064851 | 6826547 |
| 6290349 | 6428155 | 6785016 | 6831682 | 6741871 | 6927871 |
| 6980306 | 6965439 | 6840606 | 7036918 | 6977746 | 6970264 |
| 7068389 | 7093991 | 7190491 | 10/901154 | 10/932044 | 10/962412 |
| 7177054 | 10/962552 | 10/965733 | 10/965933 | 10/974742 | 10/986375 |
| 6982798 | 6870966 | 6822639 | 6737591 | 7055739 | 7233320 |
| 6830196 | 6832717 | 6957768 | 7170499 | 7106888 | 7123239 |
| 10/727181 | 10/727162 | 10/727163 | 10/727245 | 7121639 | 7165824 |
| 7152942 | 10/727157 | 7181572 | 7096137 | 10/727257 | 10/727238 |
| 7188282 | 10/727159 | 10/727180 | 10/727179 | 10/727192 | 10/727274 |
| 10/727164 | 10/727161 | 10/727198 | 10/727158 | 10/754536 | 10/754938 |
| 10/727227 | 10/727160 | 10/934720 | 10/296522 | 6795215 | 7070098 |
| 7154638 | 6805419 | 6859289 | 6977751 | 6398332 | 6394573 |
| 6622923 | 6747760 | 6921144 | 10/884881 | 7092112 | 7192106 |
| 10/854521 | 10/854522 | 10/854488 | 10/854487 | 10/854503 | 10/854504 |
| 10/854509 | 7188928 | 7093989 | 10/854497 | 10/854495 | 10/854498 |
| 10/854511 | 10/854512 | 10/854525 | 10/854526 | 10/854516 | 10/854508 |
| 10/854507 | 10/854515 | 10/854506 | 10/854505 | 10/854493 | 10/854494 |
| 10/854489 | 10/854490 | 10/854492 | 10/854491 | 10/854528 | 10/854523 |
| 10/854527 | 10/854524 | 10/854520 | 10/854514 | 10/854519 | 10/854513 |
| 10/854499 | 10/854501 | 10/854500 | 7243193 | 10/854518 | 10/854517 |
| 10/934628 | 10/760254 | 10/760210 | 10/760202 | 7201468 | 10/760198 |
| 10/760249 | 7234802 | 10/760196 | 10/760247 | 7156511 | 10/760264 |
| 10/760244 | 7097291 | 10/760222 | 10/760248 | 7083273 | 10/760192 |
| 10/760203 | 10/760204 | 10/760205 | 10/760206 | 10/760267 | 10/760270 |
| 7198352 | 10/760271 | 10/760275 | 7201470 | 7121655 | 10/760184 |
| 7232208 | 10/760186 | 10/760261 | 7083272 | 11/014764 | 11/014763 |
| 11/014748 | 11/014747 | 11/014761 | 11/014760 | 11/014757 | 11/014714 |
| 11/014713 | 11/014762 | 11/014724 | 11/014723 | 11/014756 | 11/014736 |
| 11/014759 | 11/014758 | 11/014725 | 11/014739 | 11/014738 | 11/014737 |
| 11/014726 | 11/014745 | 11/014712 | 11/014715 | 11/014751 | 11/014735 |
| 11/014734 | 11/014719 | 11/014750 | 11/014749 | 11/014746 | 11/014769 |
| 11/014729 | 11/014743 | 11/014733 | 11/014754 | 11/014755 | 11/014765 |
| 11/014766 | 11/014740 | 11/014720 | 11/014753 | 11/014752 | 11/014744 |
| 11/014741 | 11/014768 | 11/014767 | 11/014718 | 11/014717 | 11/014716 |
| 11/014732 | 11/014742 | | | | |

### FIELD OF THE INVENTION

The present invention relates to the field of inkjet printers and, discloses an inkjet printing system using printheads manufactured with microelectro-mechanical systems (MEMS) techniques.

### BACKGROUND OF THE INVENTION

Many different types of printing have been invented, a large number of which are presently in use. The known forms of print have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years, the field of ink jet printing, wherein each individual pixel of ink is derived from one or more ink nozzles has become increasingly popular primarily due to its inexpensive and versatile nature.

Many different techniques on ink jet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different types. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous inkjet printing including the step wherein the ink jet stream is modulated by a high frequency electro-static field so as to cause drop separation. This technique is still utilized by several manufacturers including Elmjet and Scitex (see also U.S. Pat. No. 3,373,437 by Sweet et al)

Piezoelectric inkjet printers are also one form of commonly utilized ink jet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode of operation of a piezoelectric crystal, Stemme in U.S. Pat. No. 3,747,120 (1972) discloses a bend mode of piezoelectric operation, Howkins in U.S. Pat. No. 4,459,601 discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclosed inkjet printing techniques that rely upon the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction operation, durability and consumables.

A problem with inkjet printheads, and especially inkjet printheads having a high nozzle density, is that ink can flood across the printhead surface contaminating adjacent nozzles. This is undesirable because it results in reduced print quality. Moreover, cross-contamination of ink across the printhead surface can potentially result in electrolysis and accelerated corrosion of nozzle actuators.

Previous attempts to minimize ink flooding across the printhead surface typically involve coating the printhead with a hydrophobic material. However, hydrophobic coatings have only had limited success in minimizing the extent of flooding.

A further problem with inkjet printheads, especially inkjet printheads having sensitive MEMS nozzles formed on an ink ejection surface of the printhead, is that the nozzle structures can become damaged by cleaning the printhead surface. Typically, printheads are wiped regularly to remove particles of paper dust or paper fibers, which build up on the ink ejection surface. When a wiping mechanism comes into contact with nozzle structures on the printhead surface, there is an obvious risk of damaging the nozzles.

It would be desirable to provide a printhead, which minimizes cross-contamination by ink flooding between adjacent nozzles. It would be further desirable to provide a printhead, which allows regular cleaning of the printhead surface by a wiping mechanism without risk of damaging nozzle structures on the printhead.

### SUMMARY OF THE INVENTION

In a first aspect, there is provided a printhead comprising:

a substrate including a plurality of nozzles for ejecting ink droplets onto a print medium, each nozzle having a nozzle aperture defined in an ink ejection surface of the substrate; and

a plurality of formations on the ink ejection surface, the surface formations being configured to isolate each nozzle from at least one adjacent nozzle.

In a second aspect, there is provided a method of operating a printhead, whilst minimizing cross-contamination of ink between adjacent nozzles, the method comprising the steps of:

(a) providing a printhead comprising:

a substrate including a plurality of nozzles for ejecting ink droplets onto a print medium, each nozzles having a nozzle aperture defined in an ink ejection surface of the substrate; and

a plurality of formations on the ink ejection surface, the surface formations being configured to isolate each nozzle from at least one adjacent nozzle; and

(b) printing onto a print medium using said printhead.

In a third aspect, there is provided a method of fabricating a printhead having isolated nozzles, the method comprising the steps of:

(a) providing a substrate, the substrate including a plurality of nozzles for ejecting ink droplets onto a print medium, each nozzle having a nozzle aperture defined in an ink ejection surface of the substrate;

(b) depositing a layer of photoresist over the ink ejection surface;

(c) defining recesses in the photoresist, each recess revealing a portion of the ink ejection surface surrounding a respective nozzle aperture;

(d) depositing a roof material over the photoresist and into the recesses;

(e) etching the roof material to define a nozzle enclosure around each nozzle aperture, each nozzle enclosure having an opening defined in a roof and sidewalls extending from the roof to the ink ejection surface; and

(f) removing the photoresist.

Optionally, the formations have a hydrophobic surface. Inkjet inks are typically aqueous-based inks and hydrophobic formations will repel any flooded ink. Hence, hydrophobic formations minimize as far as possible any cross-contamination of ink by acting as a physical barrier and by intermolecular repulsive forces. Moreover, hydrophobic formations promote ingestion of any flooded ink back into respective nozzle chambers and ink supply channels. Since nozzle chambers are typically hydrophilic, ink will tend to be drawn back into the nozzle and away from a surrounding hydrophobic formation.

Optionally, the formations are arranged in a plurality of nozzle enclosures, each nozzle enclosure comprising sidewalls surrounding a respective nozzle, the sidewalls forming a seal with the ink ejection surface. Hence, each nozzle is isolated from its adjacent nozzles by a nozzle enclosure.

Optionally, each nozzle enclosure further comprises a roof spaced apart from the respective nozzle, the roof having a roof opening aligned with a respective nozzle opening for allowing ejected ink droplets to pass therethrough onto the print medium. Hence, each nozzle enclosure may typically take the form of a cap, which covers or encapsulates an individual nozzle on the ink ejection surface. The roof not only provides additional containment of any flooded ink, it also provides further protection of each nozzle from, for example, the potentially damaging effects of paper dust, paper fibers or wiping. Typically, the sidewalls extend from a perimeter region of each roof to the ink ejection surface. Sidewalls of adjacent nozzle enclosures are usually spaced apart across the ink ejection surface.

Optionally, the printhead is an inkjet printhead, such as a pagewidth inkjet printhead. Optionally, the printhead has a nozzle density, which is sufficient to print at up to 1600 dpi. The present invention is particularly beneficial for printheads having a high nozzle density, because high density printheads are especially prone to flooding between adjacent nozzles.

### BRIEF DESCRIPTION OF THE DRAWINGS

Notwithstanding any other forms that may fall within the scope of the present invention, preferred forms of the invention will now be described, by way of example only, with reference to the accompanying drawings in which:

FIG. 1 is a schematic cross-sectional view through an ink chamber of a unit cell of a printhead according to an embodiment using a bubble forming heater element;

FIG. 2 is a schematic cross-sectional view through the ink chamber FIG. 1, at another stage of operation;

FIG. 3 is a schematic cross-sectional view through the ink chamber FIG. 1, at yet another stage of operation;

FIG. 4 is a schematic cross-sectional view through the ink chamber FIG. 1, at yet a further stage of operation; and

FIG. 5 is a diagrammatic cross-sectional view through a unit cell of a printhead in accordance with an embodiment of the invention showing the collapse of a vapor bubble.

FIG. 6 is a schematic, partially cut away, perspective view of a further embodiment of a unit cell of a printhead.

FIGS. 7 to 20 are schematic perspective views of the unit cell shown in FIG. 6, at various successive stages in the fabrication process of the printhead.

### DESCRIPTION OF OPTIONAL EMBODIMENTS

Bubble Forming Heater Element Actuator

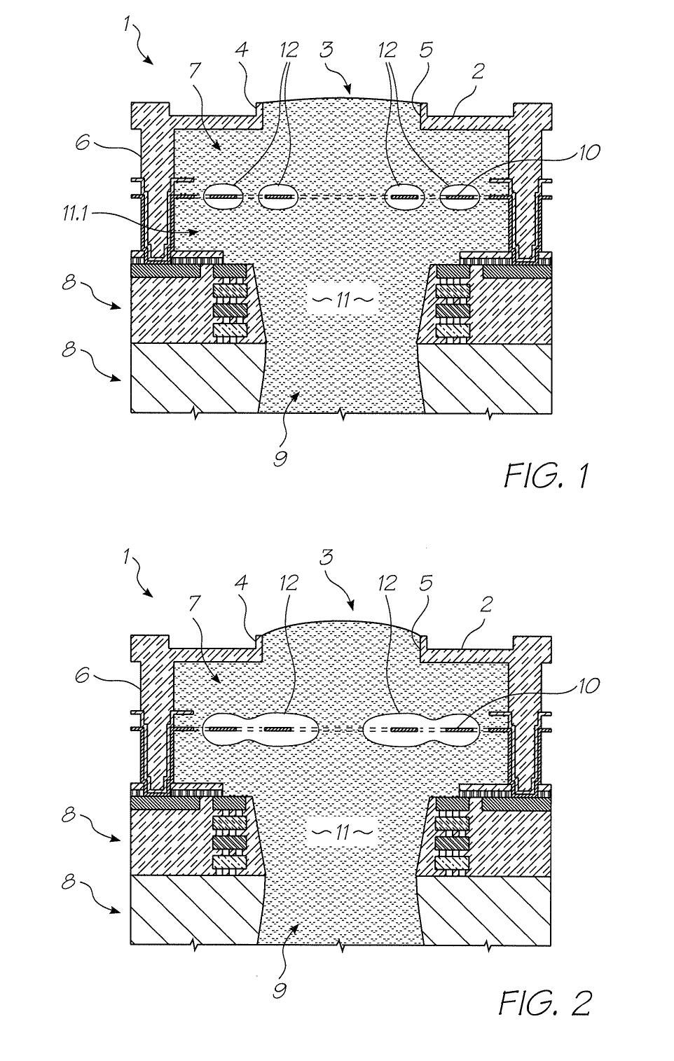

With reference to FIGS. 1 to 4, the unit cell 1 of one of the Applicant's printheads is shown. The unit cell 1 comprises a nozzle plate 2 with nozzles 3 therein, the nozzles having nozzle rims 4, and apertures 5 extending through the nozzle plate. The nozzle plate 2 is plasma etched from a silicon nitride structure which is deposited, by way of chemical vapor deposition (CVD), over a sacrificial material which is subsequently etched.

The printhead also includes, with respect to each nozzle 3, side walls 6 on which the nozzle plate is supported, a chamber 7 defined by the walls and the nozzle plate 2, a multi-layer substrate 8 and an inlet passage 9 extending through the multi-layer substrate to the far side (not shown) of the substrate. A looped, elongate heater element 10 is suspended within the chamber 7, so that the element is in the form of a suspended beam. The printhead as shown is a microelectromechanical system (MEMS) structure, which is formed by a lithographic process which is described in more detail below.

When the printhead is in use, ink 11 from a reservoir (not shown) enters the chamber 7 via the inlet passage 9, so that the chamber fills to the level as shown in FIG. 1. Thereafter, the heater element 10 is heated for somewhat less than 1 microsecond, so that the heating is in the form of a thermal pulse. It will be appreciated that the heater element 10 is in thermal contact with the ink 11 in the chamber 7 so that when the element is heated, this causes the generation of vapor bubbles 12 in the ink. Accordingly, the ink 11 constitutes a bubble forming liquid. FIG. 1 shows the formation of a bubble 12 approximately 1 microsecond after generation of the thermal pulse, that is, when the bubble has just nucleated on the heater elements 10. It will be appreciated that, as the heat is applied in the form of a pulse, all the energy necessary to generate the bubble 12 is to be supplied within that short time.

When the element 10 is heated as described above, the bubble 12 forms along the length of the element, this bubble appearing, in the cross-sectional view of FIG. 1, as four bubble portions, one for each of the element portions shown in cross section.

The bubble 12, once generated, causes an increase in pressure within the chamber 7, which in turn causes the ejection of a drop 16 of the ink 11 through the nozzle 3. The rim 4 assists in directing the drop 16 as it is ejected, so as to minimize the chance of drop misdirection.

The reason that there is only one nozzle 3 and chamber 7 per inlet passage 9 is so that the pressure wave generated within the chamber, on heating of the element 10 and forming of a bubble 12, does not affect adjacent chambers and their corresponding nozzles. The pressure wave generated within the chamber creates significant stresses in the chamber wall. Forming the chamber from an amorphous ceramic such as silicon nitride, silicon dioxide (glass) or silicon oxynitride, gives the chamber walls high strength while avoiding the use of material with a crystal structure. Crystalline defects can act as stress concentration points and therefore potential areas of weakness and ultimately failure.

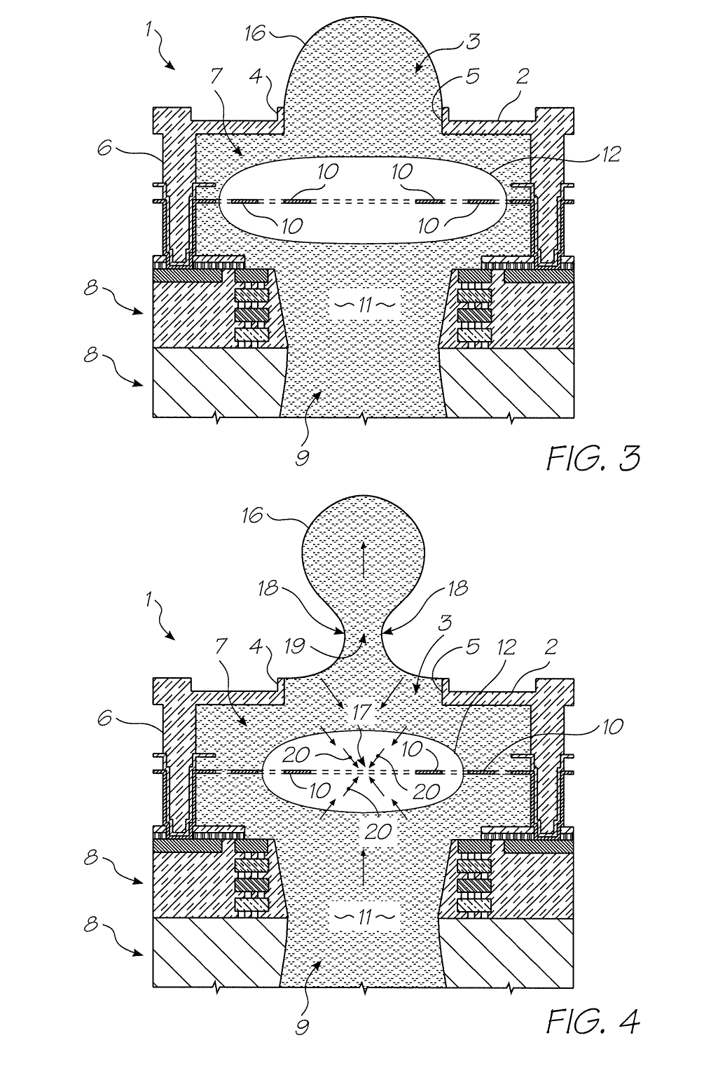

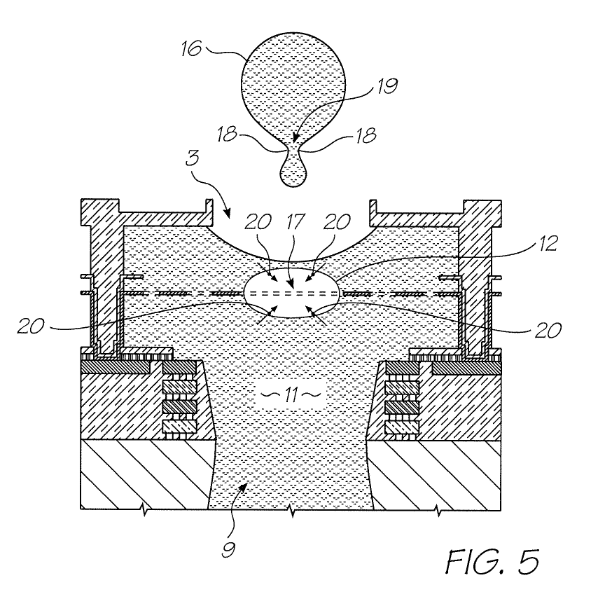

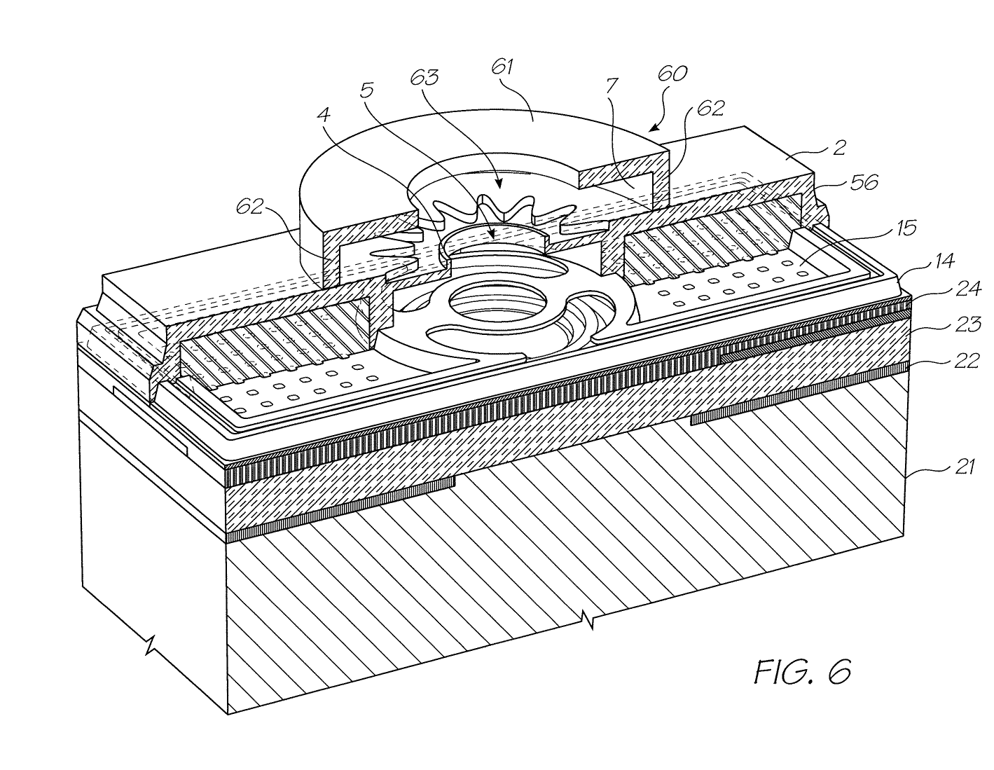

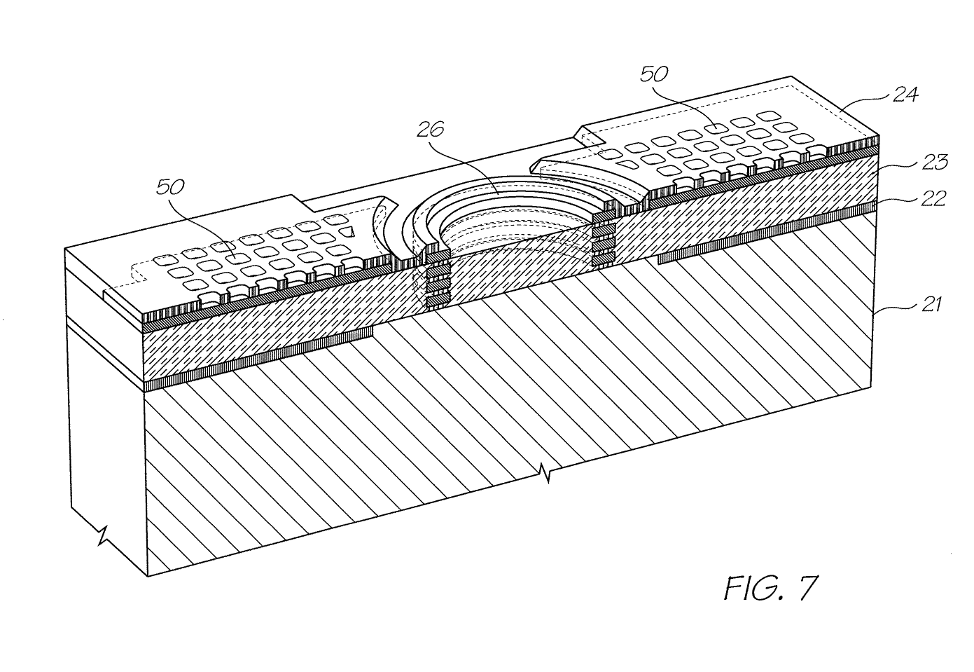

FIGS. 2 and 3 show the unit cell 1 at two successive later stages of operation of the printhead. It can be seen that the bubble 12 generates further, and hence grows, with the resultant advancement of ink 11 through the nozzle 3. The shape of the bubble 12 as it grows, as shown in FIG. 3, is determined by a combination of the inertial dynamics and the surface tension of the ink 11. The surface tension tends to minimize the surface area of the bubble 12 so that, by the time a certain amount of liquid has evaporated, the bubble is essentially disk-shaped.

The increase in pressure within the chamber 7 not only pushes ink 11 out through the nozzle 3, but also pushes some ink back through the inlet passage 9. However, the inlet passage 9 is approximately 200 to 300 microns in length, and is only approximately 16 microns in diameter. Hence there is a substantial viscous drag. As a result, the predominant effect of the pressure rise in the chamber 7 is to force ink out through the nozzle 3 as an ejected drop 16, rather than back through the inlet passage 9.

Turning now to FIG. 4, the printhead is shown at a still further successive stage of operation, in which the ink drop 16 that is being ejected is shown during its “necking phase” before the drop breaks off. At this stage, the bubble 12 has already reached its maximum size and has then begun to collapse towards the point of collapse 17, as reflected in more detail in FIG. 21.

The collapsing of the bubble 12 towards the point of collapse 17 causes some ink 11 to be drawn from within the nozzle 3 (from the sides 18 of the drop), and some to be drawn from the inlet passage 9, towards the point of collapse. Most of the ink 11 drawn in this manner is drawn from the nozzle 3, forming an annular neck 19 at the base of the drop 16 prior to its breaking off.

The drop 16 requires a certain amount of momentum to overcome surface tension forces, in order to break off. As ink 11 is drawn from the nozzle 3 by the collapse of the bubble 12, the diameter of the neck 19 reduces thereby reducing the amount of total surface tension holding the drop, so that the momentum of the drop as it is ejected out of the nozzle is sufficient to allow the drop to break off.

When the drop 16 breaks off, cavitation forces are caused as reflected by the arrows 20, as the bubble 12 collapses to the point of collapse 17. It will be noted that there are no solid surfaces in the vicinity of the point of collapse 17 on which the cavitation can have an effect.

Advantages of Nozzle Enclosures

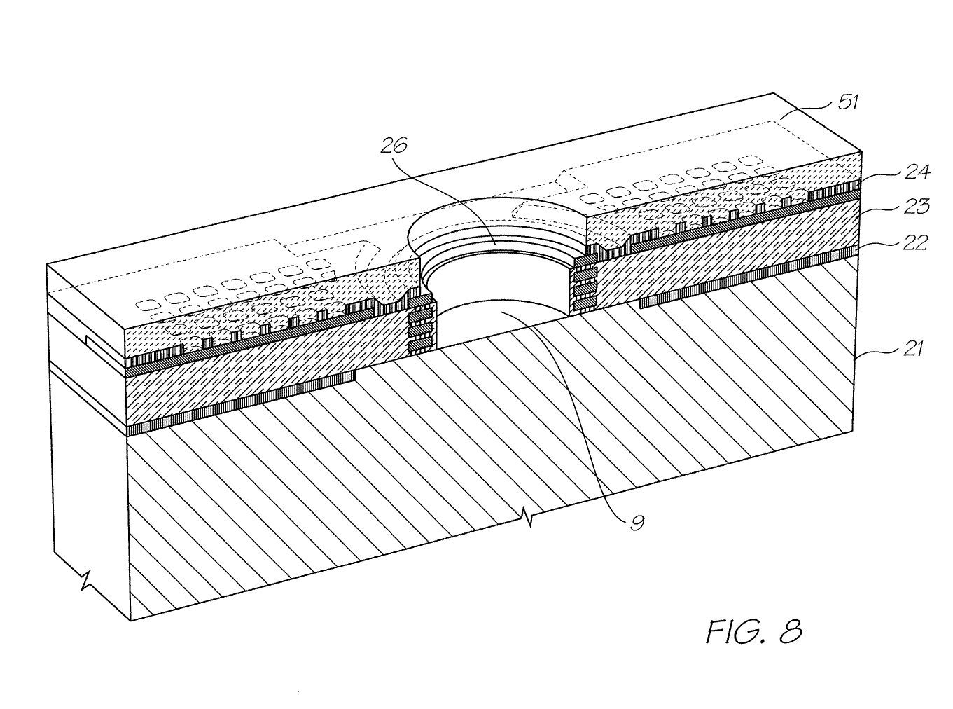

Referring to FIG. 6, an embodiment of the unit cell 1 according to the invention is shown. The aperture 5 is surrounded by a nozzle enclosure 60, which isolates adjacent apertures on the printhead. The nozzle enclosure 60 has a roof 61 and sidewalls 62, which extend from the roof to the nozzle plate 2 and form a seal therewith. An opening 63 is defined in the roof 61, which allows ink droplets (not shown) to pass through the nozzle enclosure and onto a print medium (not shown).

The nozzle enclosure 60 minimize cross-contamination between adjacent apertures 5 by containing any flooded ink in the immediate vicinity of each nozzle. Flooding of ink from each nozzle may be caused by a variety of reasons, such as nozzle misfires or pressure fluctuations in ink supply channels. The nozzle enclosure may be formed from or coated with a hydrophobic material during the fabrication process, which further minimizes the risk of cross-contamination.

A further advantage of the printhead according to the invention is that it allows the nozzle plate 2 of the printhead to be wiped without risk of damaging the sensitive nozzle structures. Typically, inkjet printheads are cleaned by a wiping mechanism as part of a warm-up cycle. The nozzle enclosures 60 provide a protective barrier between the nozzles and the wiping mechanism (not shown).

Fabrication Process

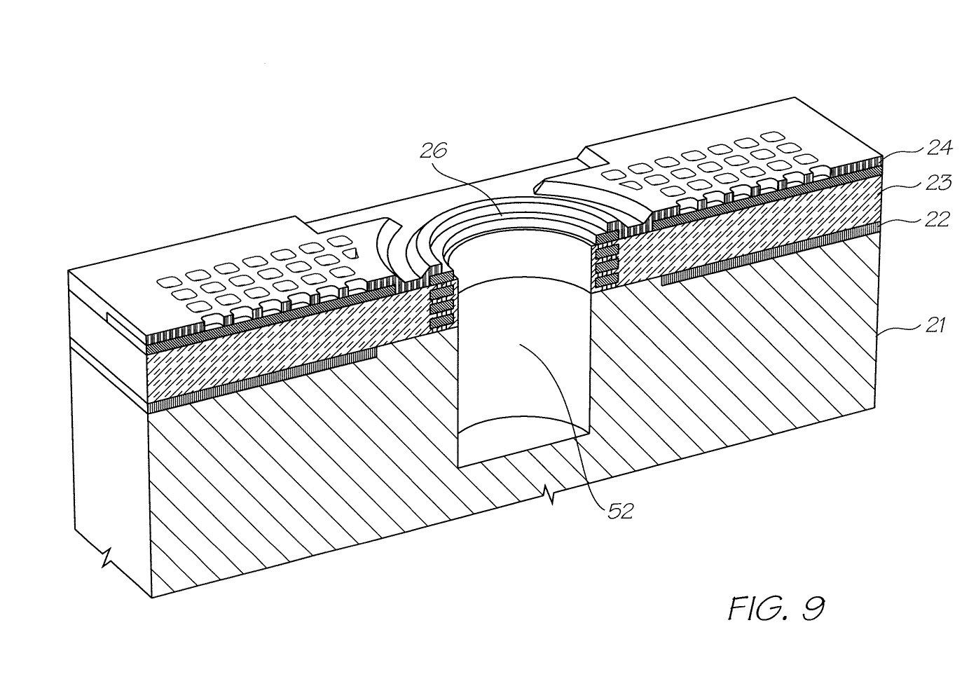

In the interests of brevity, the fabrication stages have been shown for the unit cell of FIG. 6 only (see FIGS. 7 to 20). It will be appreciated that the other unit cells will use the same fabrication stages with different masking.

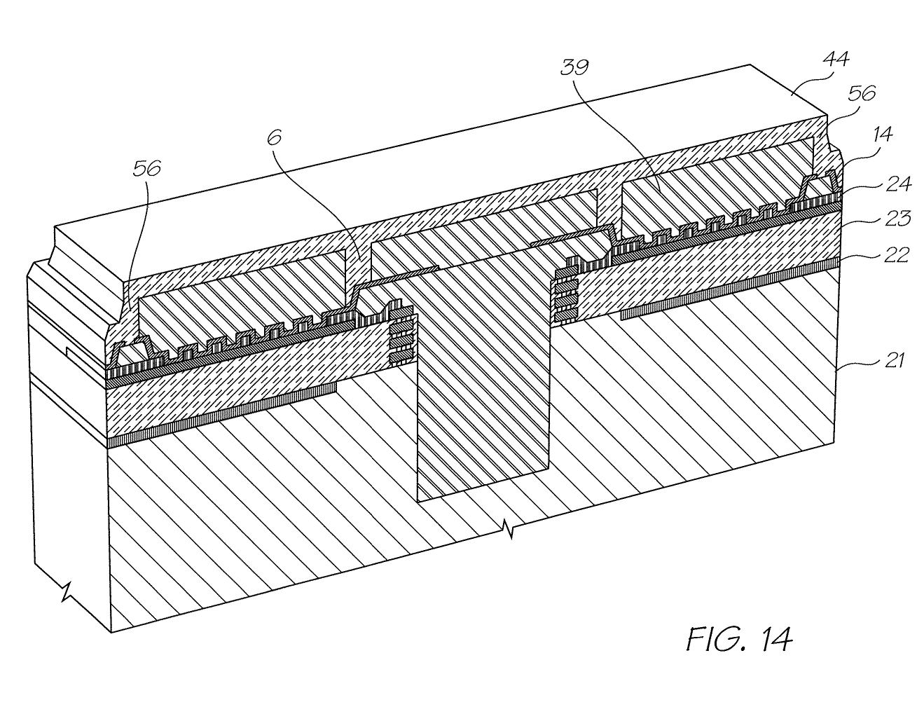

Referring to FIG. 7, there is shown the starting point for fabrication of the thermal inkjet nozzle shown in FIG. 13. CMOS processing of a silicon wafer provides a silicon substrate 21 having drive circuitry 22, and an interlayer dielectric (“interconnect”) 23. The interconnect 23 comprises four metal layers, which together form a seal ring for the inlet passage 9 to be etched through the interconnect. The top metal layer 26, which forms an upper portion of the seal ring, can be seen in FIG. 7. The metal seal ring prevents ink moisture from seeping into the interconnect 23 when the inlet passage 9 is filled with ink.

A passivation layer 24 is deposited onto the top metal layer 26 by plasma-enhanced chemical vapour deposition (PECVD). After deposition of the passivation layer 24, it is etched to define a circular recess, which forms parts of the inlet passage 9. At the same as etching the recess, a plurality of vias 50 are also etched, which allow electrical connection through the passivation layer 24 to the top metal layer 26. The etch pattern is defined by a layer of patterned photoresist (not shown), which is removed by O₂ ashing after the etch.

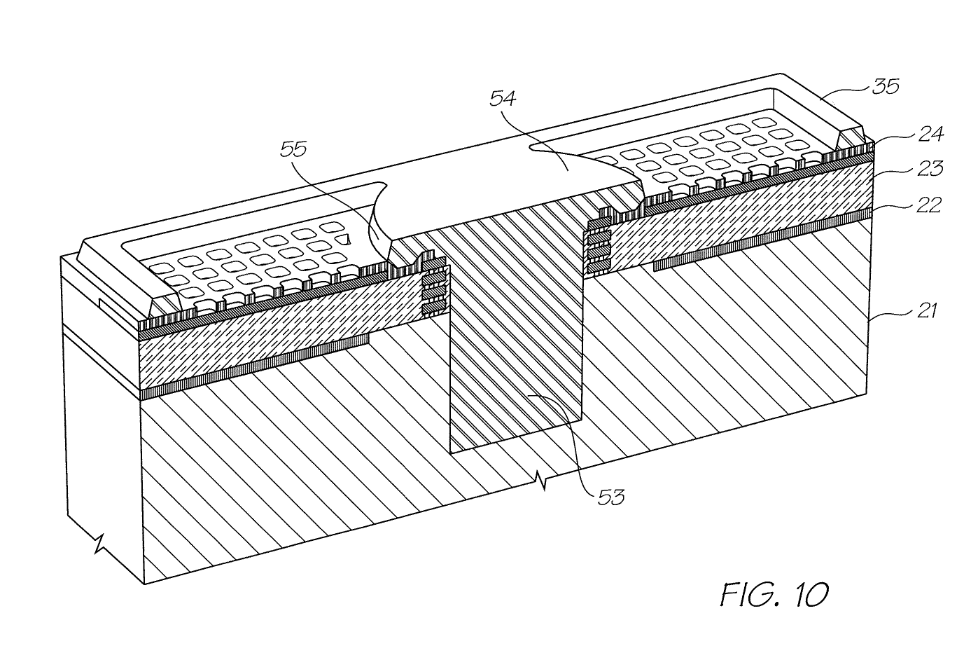

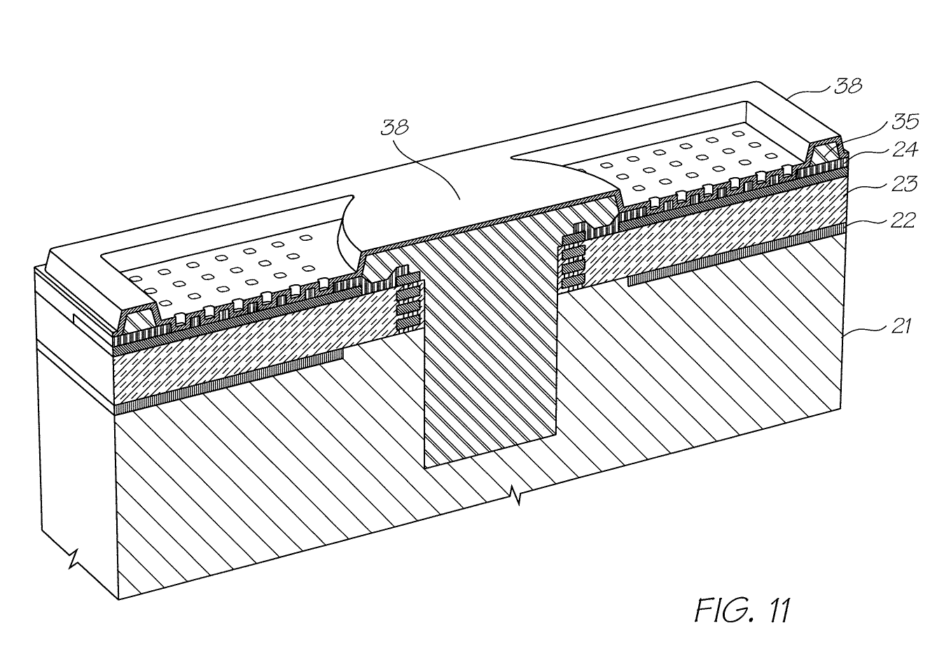

Referring to FIG. 8, in the next fabrication sequence, a layer of photoresist is spun onto the passivation later 24. The photoresist is exposed and developed to define a circular opening. With the patterned photoresist 51 in place, the dielectric interconnect 23 is etched as far as the silicon substrate 21 using a suitable oxide-etching gas chemistry (eg. O₂/C₄F₈). Etching through the silicon substrate is continued down to about 20 microns to define a front ink hole 52, using a suitable silicon-etching gas chemistry (e.g. ‘Bosch etch’). The same photoresist mask 51 can be used for both etching steps. FIG. 9 shows the unit cell after etching the front ink hole 52 and removal of the photoresist 51.

Referring to FIG. 10, in the next stage of fabrication, the front ink hole 52 is plugged with photoresist to provide a front plug 53. At the same time, a layer of photoresist is deposited over the passivation layer 24. This layer of photoresist is exposed and developed to define a first sacrificial scaffold 54 over the front plug 53, and scaffolding tracks 35 around the perimeter of the unit cell. The first sacrificial scaffold 54 is used for subsequent deposition of heater material 38 thereon and is therefore formed with a planar upper surface to avoid any buckling in the heater element (see heater element 10 in FIG. 10). The first sacrificial scaffold 54 is UV cured and hardbaked to prevent reflow of the photoresist during subsequent high-temperature deposition onto its upper surface.

Importantly, the first sacrificial scaffold 54 has sloped or angled side faces 55. These angled side faces 55 are formed by adjusting the focusing in the exposure tool (e.g. stepper) when exposing the photoresist. The sloped side faces 55 advantageously allow heater material 38 to be deposited substantially evenly over the first sacrificial scaffold 54.

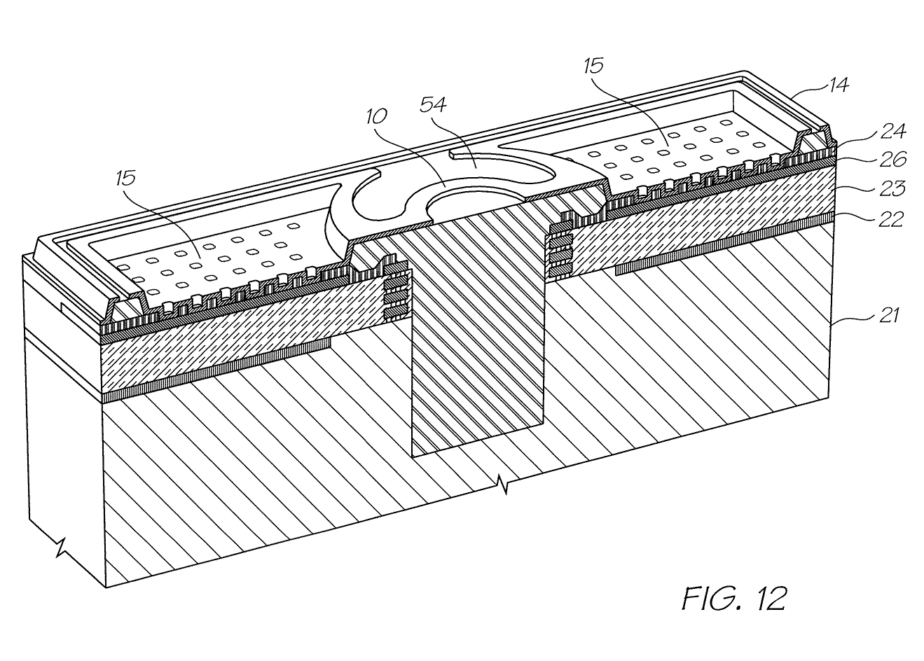

Referring to FIG. 11, the next stage of fabrication deposits the heater material 38 over the first sacrificial scaffold 54, the passivation layer 24 and the perimeter scaffolding tracks 35. The heater material 38 is typically a monolayer of TiAlN. However, the heater material 38 may alternatively comprise TiAlN sandwiched between upper and lower passivating materials, such as tantalum or tantalum nitride. Passivating layers on the heater element 10 minimize corrosion of the and improve heater longevity.

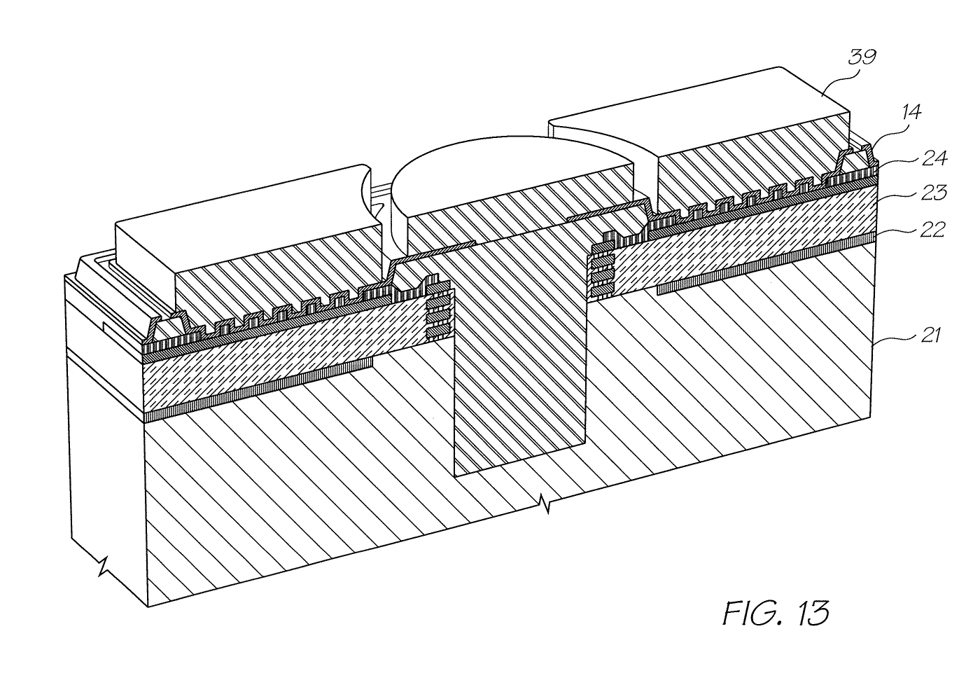

Referring to FIG. 12, the heater material 38 is subsequently etched down to the first sacrificial scaffold 54 to define the heater element 10. At the same time, contact electrodes 15 are defined on either side of the heater element 10. The electrodes 15 are in contact with the top metal layer 26 and so provide electrical connection between the CMOS and the heater element 10. The sloped side faces of the first sacrificial scaffold 54 ensure good electrical connection between the heater element 10 and the electrodes 15, since the heater material is deposited with sufficient thickness around the scaffold 54. Any thin areas of heater material (due to insufficient side face deposition) would increase resistivity and affect heater performance.

Adjacent unit cells are electrically insulated from each other by virtue of grooves etched around the perimeter of each unit cell. The grooves are etched at the same time as defining the heater element 10.

Referring to FIG. 13, in the subsequent step a second sacrificial scaffold 39 of photoresist is deposited over the heater material. The second sacrificial scaffold 39 is exposed and developed to define sidewalls for the cylindrical nozzle chamber and perimeter sidewalls for each unit cell. The second sacrificial scaffold 39 is also UV cured and hardbaked to prevent any reflow of the photoresist during subsequent high-temperature deposition of the silicon nitride roof material.

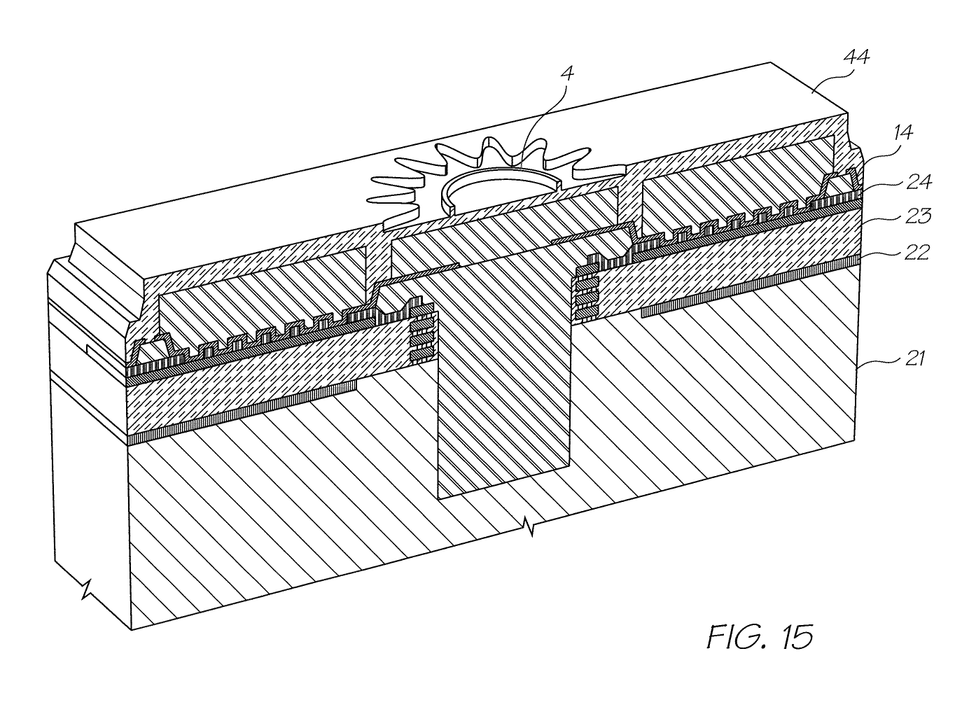

Referring to FIG. 14, silicon nitride is deposited onto the second sacrificial scaffold 39 by plasma enhanced chemical vapour deposition. The silicon nitride forms a roof 44 over each unit cell, which is the nozzle plate 2 for a row of nozzles. Chamber sidewalls 6 and unit cell sidewalls 56 are also formed by deposition of silicon nitride.

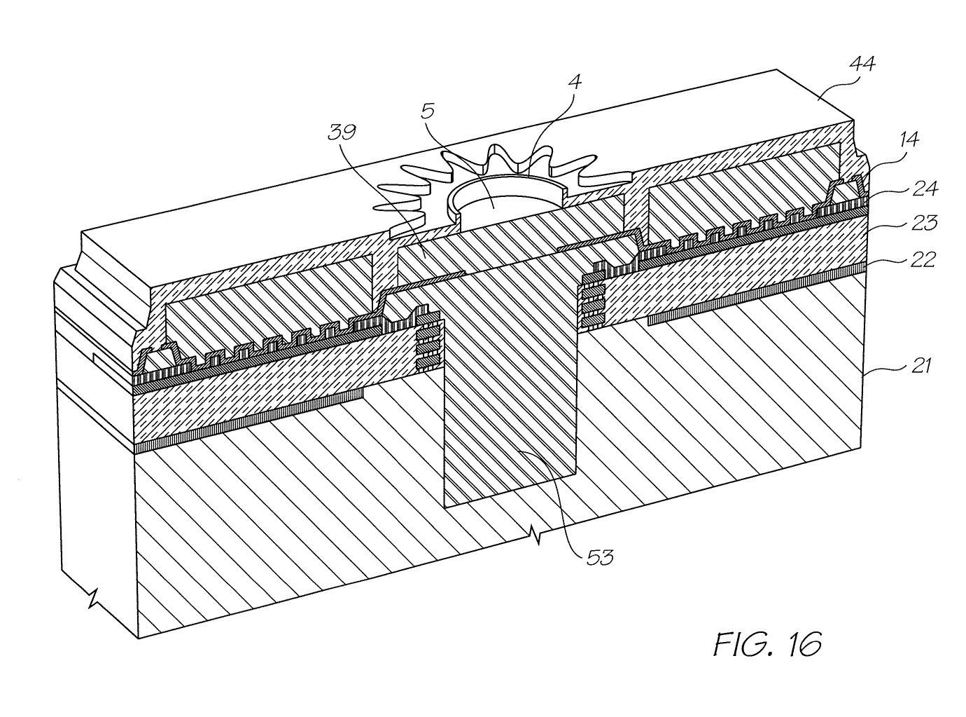

Referring to FIG. 15, the nozzle rim 4 is etched partially through the roof 44, by placing a suitably patterned photoresist mask over the roof, etching for a controlled period of time and removing the photoresist by ashing.

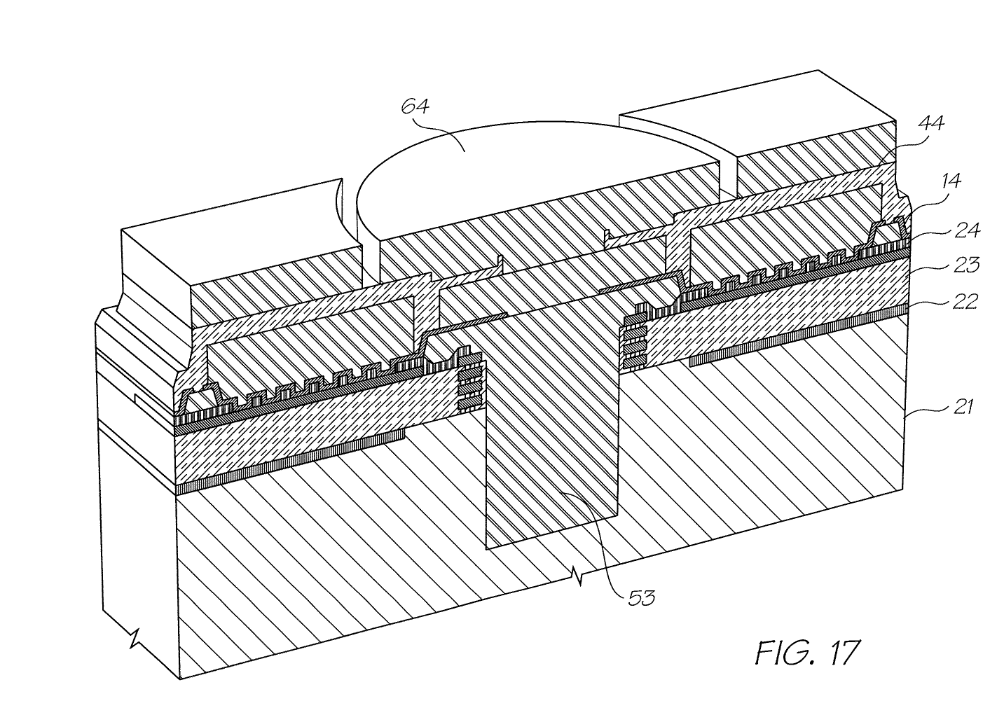

Referring to FIG. 16, the nozzle aperture 5 is etched through the roof 24 down to the second sacrificial scaffold 39. Again, the etch is performed by placing a suitably patterned photoresist mask over the roof, etching down to the scaffold 39 and removing the photoresist mask.

Referring to FIG. 17, in the next stage a third sacrificial scaffold 64 is deposited over the roof 44. The third sacrificial scaffold 64 is exposed and developed to define sidewalls for the cylindrical nozzle enclosure over each aperture 5. The third sacrificial scaffold 64 is also UV cured and hardbaked to prevent any reflow of the photoresist during subsequent high-temperature deposition of the nozzle enclosure material.

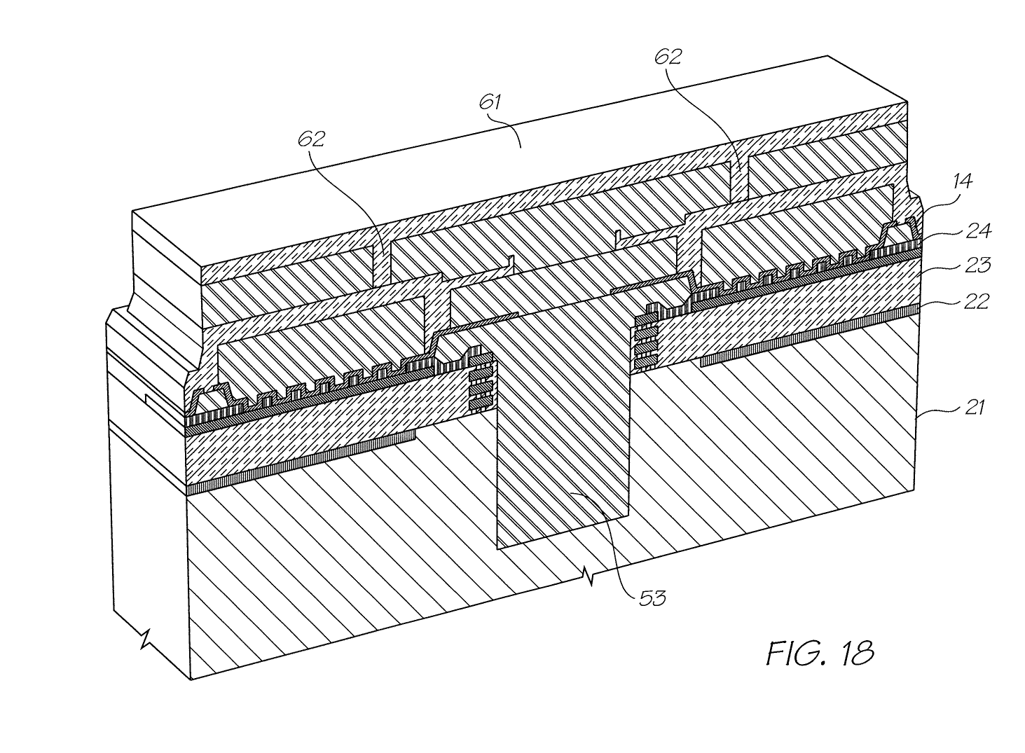

Referring to FIG. 18, silicon nitride is deposited onto the third sacrificial scaffold 64 by plasma enhanced chemical vapour deposition. The silicon nitride forms an enclosure roof 61 over each aperture 5. Enclosure sidewalls 62 are also formed by deposition of silicon nitride. Whilst silicon nitride is deposited in the embodiment shown, the enclosure roof 61 may equally be formed from silicon oxide, silicon oxynitride etc. Optionally, a layer of hydrophobic material (e.g. fluoropolymer) is deposited onto the enclosure roof 61 after deposition. This extra deposition step may be performed at any stage after deposition (e.g. after etching or after ashing).

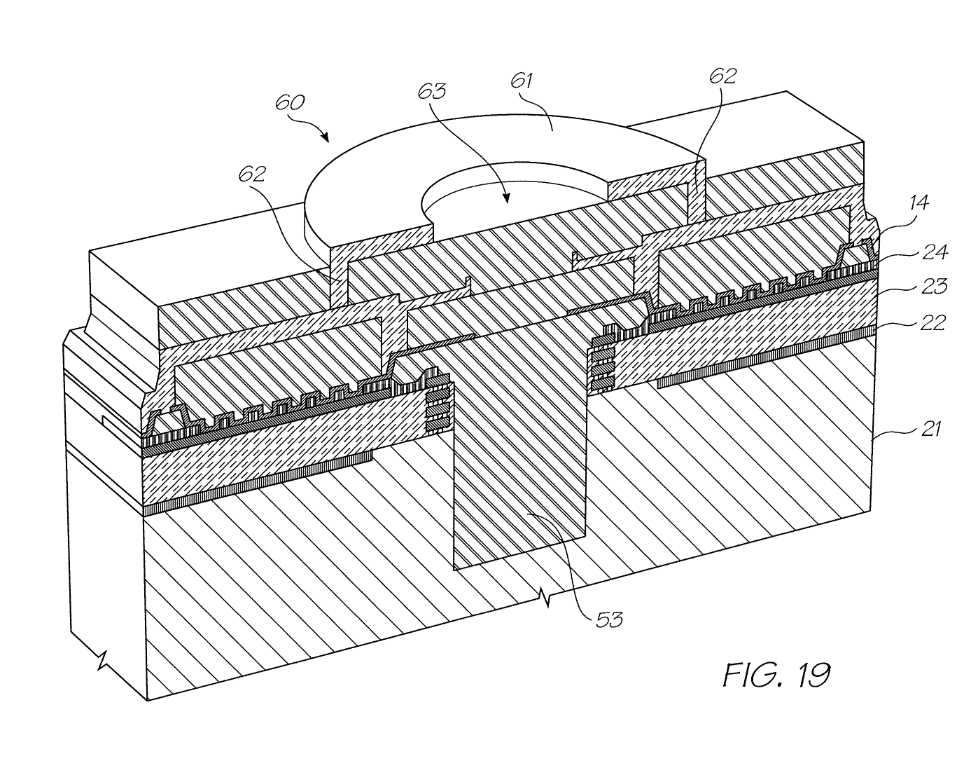

Referring to FIG. 19, the nozzle enclosure 60 is formed by etching through the enclosure roof layer 61. The enclosure opening 63 is defined by this etch. In addition, the enclosure roof material which is located outside the enclosure sidewalls 62 is removed. The etch pattern is defined by standard photoresist masking.

With the nozzle structure, including nozzle enclosure 60, now fully formed on a frontside of the silicon substrate 21, an ink supply channel 32 is etched from the backside of the substrate 21, which meets with the front plug 53.

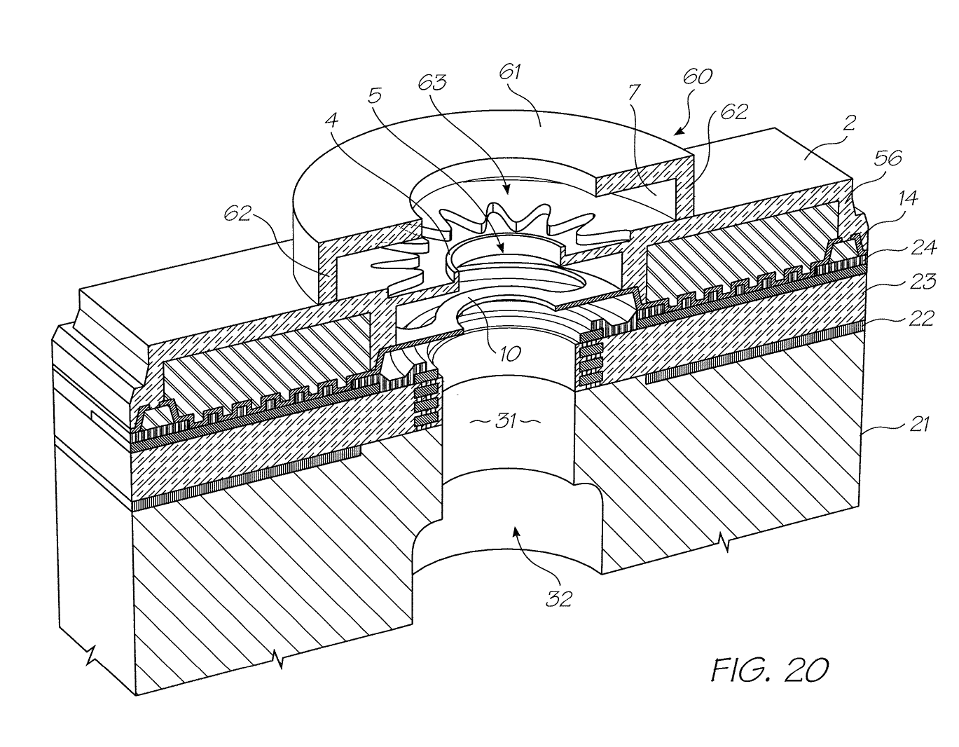

Referring to FIG. 20, after formation of the ink supply channel 32, the first, second and sacrificial scaffolds of photoresist, together with the front plug 53 are ashed off using an O₂ plasma. Accordingly, fluid connection is made from the ink supply channel 32 through to the nozzle aperture 5 and the nozzle enclosure opening 63.

It should be noted that a portion of photoresist, on either side of the nozzle chamber sidewalls 6, remains encapsulated by the roof 44, the unit cell sidewalls 56 and the chamber sidewalls 6. This portion of photoresist is sealed from the O₂ ashing plasma and, therefore, remains intact after fabrication of the printhead. This encapsulated photoresist advantageously provides additional robustness for the printhead by supporting the nozzle plate 2. Hence, the printhead has a robust nozzle plate spanning continuously over rows of nozzles, and being supported by solid blocks of hardened photoresist, in addition to support walls.

### Other Embodiments

The invention has been described above with reference to printheads using bubble forming heater elements. However, it is potentially suited to a wide range of printing system including: color and monochrome office printers, short run digital printers, high speed digital printers, offset press supplemental printers, low cost scanning printers high speed pagewidth printers, notebook computers with inbuilt pagewidth printers, portable color and monochrome printers, color and monochrome copiers, color and monochrome facsimile machines, combined printer, facsimile and copying machines, label printers, large format plotters, photograph copiers, printers for digital photographic “minilabs”, video printers, PHOTO CD (PHOTO CD is a registered trade mark of the Eastman Kodak Company) printers, portable printers for PDAs, wallpaper printers, indoor sign printers, billboard printers, fabric printers, camera printers and fault tolerant commercial printer arrays.

It will be appreciated by ordinary workers in this field that numerous variations and/or modifications may be made to the present invention as shown in the specific embodiments without departing from the spirit or scope of the invention as broadly described. The present embodiments are, therefore, to be considered in all respects to be illustrative and not restrictive.

Ink Jet Technologies

The embodiments of the invention use an ink jet printer type device. Of course many different devices could be used. However presently popular ink jet printing technologies are unlikely to be suitable.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. In conventional thermal inkjet printheads, this leads to an efficiency of around 0.02%, from electricity input to drop momentum (and increased surface area) out.

The most significant problem with piezoelectric ink jet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty-five different inkjet technologies have been developed by the Assignee to give a wide range of choices for high volume manufacture. These technologies form part of separate applications assigned to the present Assignee as set out in the table under the heading Cross References to Related Applications.

The ink jet designs shown here are suitable for a wide range of digital printing systems, from battery powered one-time use digital cameras, through to desktop and network printers, and through to commercial printing systems.

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest printhead designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The printhead is connected to the camera circuitry by tape automated bonding.

Tables of Drop-On-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of inkjet nozzle. While not all of the possible combinations result in a viable ink jet technology, many million configurations are viable. It is clearly impractical to elucidate all of the possible configurations. Instead, certain ink jet types have been investigated in detail. These are designated IJ01 to IJ45 above which matches the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet printheads with characteristics superior to any currently available ink jet technology.

Where there are prior art examples known to the inventor, one or more of these examples are listed in the examples column of the tables below. The IJ01 to IJ45 series are also listed in the examples column. In some cases, print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

Actuator mechanism (applied only to selected ink drops)

| | Description | Advantages | Disadvantages | Examples |
|---|---|---|---|---|
| Thermal | An electrothermal | Large force | High power | Canon Bubblejet |
| bubble | heater heats the | generated | Ink carrier limited | 1979 Endo et al |
| | ink to above | Simple | to water | GB patent |
| | boiling point, | construction | Low efficiency | 2,007,162 |
| | transferring | No moving parts | High temperatures | Xerox heater-in-pit |
| | significant heat to | Fast operation | required | 1990 Hawkins et |
| | the aqueous ink. A | Small chip area | High mechanical | al U.S. Pat. No. 4,899,181 |
| | bubble nucleates | required for | stress | Hewlett-Packard |
| | and quickly forms, | actuator | Unusual materials | TIJ 1982 Vaught |
| | expelling the ink. | | required | et al U.S. Pat. No. |
| | The efficiency of | | Large drive | 4,490,728 |
| | the process is low, | | transistors | |
| | with typically less | | Cavitation causes | |
| | than 0.05% of the | | actuator failure | |
| | electrical energy | | Kogation reduces | |
| | being transformed | | bubble formation | |
| | into kinetic energy | | Large print heads | |
| | of the drop. | | are difficult to | |
| | | | fabricate | |
| Piezoelectric | A piezoelectric | Low power | Very large area | Kyser et al U.S. Pat. No. |
| | crystal such as | consumption | required for | 3,946,398 |
| | lead lanthanum | Many ink types | actuator | Zoltan U.S. Pat. No. |
| | zirconate (PZT) is | can be used | Difficult to | 3,683,212 |
| | electrically | Fast operation | integrate with | 1973 Stemme U.S. Pat. No. |
| | activated, and | High efficiency | electronics | 3,747,120 |
| | either expands, | | High voltage drive | Epson Stylus |
| | shears, or bends to | | transistors required | Tektronix |
| | apply pressure to | | Full pagewidth | IJ04 |
| | the ink, ejecting | | print heads | |
| | drops. | | impractical due to | |
| | | | actuator size | |
| | | | Requires electrical | |
| | | | poling in high field | |
| | | | strengths during | |
| | | | manufacture | |
| Electro- | An electric field is | Low power | Low maximum | Seiko Epson, Usui |
| strictive | used to activate | consumption | strain (approx. | et all JP 253401/96 |
| | electrostriction in | Many ink types | 0.01%) | IJ04 |
| | relaxor materials | can be used | Large area | |
| | such as lead | Low thermal | required for | |
| | lanthanum | expansion | actuator due to low | |
| | zirconate titanate | Electric field | strain | |
| | (PLZT) or lead | strength required | Response speed is | |
| | magnesium | (approx. 3.5 V/μm) | marginal (˜10 μs) | |
| | niobate (PMN). | can be | High voltage drive | |
| | | generated without | transistors required | |
| | | difficulty | Full pagewidth | |
| | | Does not require | print heads | |
| | | electrical poling | impractical due to | |
| | | | actuator size | |
| Ferroelectric | An electric field is | Low power | Difficult to | IJ04 |
| | used to induce a | consumption | integrate with | |
| | phase transition | Many ink types | electronics | |
| | between the | can be used | Unusual materials | |
| | antiferroelectric | Fast operation | such as PLZSnT | |
| | (AFE) and | (<1 μs) | are required | |
| | ferroelectric (FE) | Relatively high | Actuators require a | |
| | phase. Perovskite | longitudinal strain | large area | |
| | materials such as | High efficiency | | |
| | tin modified lead | Electric field | | |
| | lanthanum | strength of around | | |
| | zirconate titanate | 3 V/μm can be | | |
| | (PLZSnT) exhibit | readily provided | | |
| | large strains of up | | | |
| | to 1% associated | | | |
| | with the AFE to | | | |
| | FE phase | | | |
| | transition. | | | |
| Electrostatic | Conductive plates | Low power | Difficult to operate | IJ02, IJ04 |
| plates | are separated by a | consumption | electrostatic | |
| | compressible or | Many ink types | devices in an | |
| | fluid dielectric | can be used | aqueous | |
| | (usually air). Upon | Fast operation | environment | |
| | application of a | | The electrostatic | |
| | voltage, the plates | | actuator will | |
| | attract each other | | normally need to | |
| | and displace ink, | | be separated from | |
| | causing drop | | the ink | |
| | ejection. The | | Very large area | |
| | conductive plates | | required to achieve | |
| | may be in a comb | | high forces | |
| | or honeycomb | | High voltage drive | |
| | structure, or | | transistors may be | |
| | stacked to increase | | required | |
| | the surface area | | Full pagewidth | |
| | and therefore the | | print heads are not | |
| | force. | | competitive due to | |
| | | | actuator size | |
| Electrostatic | A strong electric | Low current | High voltage | 1989 Saito et al, |
| pull | field is applied to | consumption | required | U.S. Pat. No. 4,799,068 |
| on ink | the ink, whereupon | Low temperature | May be damaged | 1989 Miura et al, |
| | electrostatic | | by sparks due to | U.S. Pat. No. 4,810,954 |
| | attraction | | air breakdown | Tone-jet |
| | accelerates the ink | | Required field | |
| | towards the print | | strength increases | |
| | medium. | | as the drop size | |
| | | | decreases | |
| | | | High voltage drive | |
| | | | transistors required | |
| | | | Electrostatic field | |
| | | | attracts dust | |
| Permanent | An electromagnet | Low power | Complex | IJ07, IJ10 |
| magnet | directly attracts a | consumption | fabrication | |
| electro- | permanent magnet, | Many ink types | Permanent | |
| magnetic | displacing ink and | can be used | magnetic material | |
| | causing drop | Fast operation | such as | |
| | ejection. Rare | High efficiency | Neodymium Iron | |
| | earth magnets with | Easy extension | Boron (NdFeB) | |
| | a field strength | from single | required. | |
| | around 1 Tesla can | nozzles to | High local currents | |
| | be used. Examples | pagewidth print | required | |
| | are: Samarium | heads | Copper | |
| | Cobalt (SaCo) and | | metalization | |
| | magnetic materials | | should be used for | |
| | in the neodymium | | long | |
| | iron boron family | | electromigration | |
| | (NdFeB, | | lifetime and low | |
| | NdDyFeBNb, | | resistivity | |
| | NdDyFeB, etc) | | Pigmented inks are | |
| | | | usually infeasible | |
| | | | Operating | |
| | | | temperature | |
| | | | limited to the | |
| | | | Curie temperature | |
| | | | (around 540 K) | |
| Soft | A solenoid | Low power | Complex | IJ01, IJ05, IJ08, |
| magnetic | induced a | consumption | fabrication | IJ10, IJ12, IJ14, |
| core | magnetic field in a | Many ink types | Materials not | IJ15, IJ17 |
| electro- | soft magnetic core | can be used | usually present in | |
| magnetic | or yoke fabricated | Fast operation | a CMOS fab such | |
| | from a ferrous | High efficiency | as NiFe, CoNiFe, | |
| | material such as | Easy extension | or CoFe are | |
| | electroplated iron | from single | required | |
| | alloys such as | nozzles to | High local currents | |
| | CoNiFe [1], CoFe, | pagewidth print | required | |
| | or NiFe alloys. | heads | Copper | |
| | Typically, the soft | | metalization | |
| | magnetic material | | should be used for | |
| | is in two parts, | | long | |
| | which are | | electromigration | |
| | normally held | | lifetime and low | |
| | apart by a spring. | | resistivity | |
| | When the solenoid | | Electroplating is | |
| | is actuated, the two | | required | |
| | parts attract, | | High saturation | |
| | displacing the ink. | | flux density is | |
| | | | required (2.0-2.1 T | |
| | | | is achievable with | |
| | | | CoNiFe [1]) | |
| Lorenz | The Lorenz force | Low power | Force acts as a | IJ06, IJ11, IJ13, |
| force | acting on a current | consumption | twisting motion | IJ16 |
| | carrying wire in a | Many ink types | Typically, only a | |
| | magnetic field is | can be used | quarter of the | |
| | utilized. | Fast operation | solenoid length | |
| | This allows the | High efficiency | provides force in a | |
| | magnetic field to | Easy extension | useful direction | |
| | be supplied | from single | High local currents | |
| | externally to the | nozzles to | required | |
| | print head, for | pagewidth print | Copper | |
| | example with rare | heads | metalization | |
| | earth permanent | | should be used for | |
| | magnets. | | long | |
| | Only the current | | electromigration | |
| | carrying wire need | | lifetime and low | |
| | be fabricated on | | resistivity | |
| | the print-head, | | Pigmented inks are | |
| | simplifying | | usually infeasible | |
| | materials | | | |
| | requirements. | | | |
| Magneto- | The actuator uses | Many ink types | Force acts as a | Fischenbeck, U.S. Pat. No. |
| striction | the giant | can be used | twisting motion | 4,032,929 |
| | magnetostrictive | Fast operation | Unusual materials | IJ25 |
| | effect of materials | Easy extension | such as Terfenol-D | |
| | such as Terfenol-D | from single | are required | |
| | (an alloy of | nozzles to | High local currents | |
| | terbium, | pagewidth print | required | |
| | dysprosium and | heads | Copper | |
| | iron developed at | High force is | metalization | |
| | the Naval | available | should be used for | |
| | Ordnance | | long | |
| | Laboratory, hence | | electromigration | |
| | Ter-Fe-NOL). For | | lifetime and low | |
| | best efficiency, the | | resistivity | |
| | actuator should be | | Pre-stressing may | |
| | pre-stressed to | | be required | |
| | approx. 8 MPa. | | | |
| Surface | Ink under positive | Low power | Requires | Silverbrook, EP |
| tension | pressure is held in | consumption | supplementary | 0771 658 A2 and |
| reduction | a nozzle by surface | Simple | force to effect drop | related patent |
| | tension. The | construction | separation | applications |
| | surface tension of | No unusual | Requires special | |
| | the ink is reduced | materials required | ink surfactants | |
| | below the bubble | in fabrication | Speed may be | |
| | threshold, causing | High efficiency | limited by | |
| | the ink to egress | Easy extension | surfactant | |
| | from the nozzle. | from single | properties | |
| | | nozzles to | | |
| | | pagewidth print | | |
| | | heads | | |
| Viscosity | The ink viscosity | Simple | Requires | Silverbrook, EP |
| reduction | is locally reduced | construction | supplementary | 0771 658 A2 and |
| | to select which | No unusual | force to effect drop | related patent |
| | drops are to be | materials required | separation | applications |
| | ejected. A | in fabrication | Requires special | |
| | viscosity reduction | Easy extension | ink viscosity | |
| | can be achieved | from single | properties | |
| | electrothermally | nozzles to | High speed is | |
| | with most inks, but | pagewidth print | difficult to achieve | |
| | special inks can be | heads | Requires | |
| | engineered for a | | oscillating ink | |
| | 100:1 viscosity | | pressure | |
| | reduction. | | A high | |
| | | | temperature | |
| | | | difference | |
| | | | (typically 80 | |
| | | | degrees) is | |
| | | | required | |
| Acoustic | An acoustic wave | Can operate | Complex drive | 1993 Hadimioglu |
| | is generated and | without a nozzle | circuitry | et al, EUP 550,192 |
| | focussed upon the | plate | Complex | 1993 Elrod et al, |
| | drop ejection | | fabrication | EUP 572,220 |
| | region. | | Low efficiency | |
| | | | Poor control of | |
| | | | drop position | |
| | | | Poor control of | |
| | | | drop volume | |
| Thermo- | An actuator which | Low power | Efficient aqueous | IJ03, IJ09, IJ17, |
| elastic | relies upon | consumption | operation requires | IJ18, IJ19, IJ20, |
| bend | differential | Many ink types | a thermal insulator | IJ21, IJ22, IJ23, |
| actuator | thermal expansion | can be used | on the hot side | IJ24, IJ27, IJ28, |
| | upon Joule heating | Simple planar | Corrosion | IJ29, IJ30, IJ31, |
| | is used. | fabrication | prevention can be | IJ32, IJ33, IJ34, |
| | | Small chip area | difficult | IJ35, IJ36, IJ37, |
| | | required for each | Pigmented inks | IJ38, IJ39, IJ40, |
| | | actuator | may be infeasible, | IJ41 |
| | | Fast operation | as pigment | |
| | | High efficiency | particles may jam | |
| | | CMOS compatible | the bend actuator | |
| | | voltages and | | |
| | | currents | | |
| | | Standard MEMS | | |
| | | processes can be | | |
| | | used | | |
| | | Easy extension | | |
| | | from single | | |
| | | nozzles to | | |
| | | pagewidth print | | |
| | | heads | | |
| High CTE | A material with a | High force can be | Requires special | IJ09, IJ17, IJ18, |
| thermo- | very high | generated | material (e.g. | IJ20, IJ21, IJ22, |
| elastic | coefficient of | Three methods of | PTFE) | IJ23, IJ24, IJ27, |
| actuator | thermal expansion | PTFE deposition | Requires a PTFE | IJ28, IJ29, IJ30, |
| | (CTE) such as | are under | deposition process, | IJ31, IJ42, IJ43, |
| | polytetrafluoroethylene | development: | which is not yet | IJ44 |
| | (PTFE) is | chemical vapor | standard in ULSI | |
| | used. As high CTE | deposition (CVD), | fabs | |
| | materials are | spin coating, and | PTFE deposition | |
| | usually non- | evaporation | cannot be followed | |
| | conductive, a | PTFE is a | with high | |
| | heater fabricated | candidate for low | temperature | |
| | from a conductive | dielectric constant | (above 350° C.) | |
| | material is | insulation in ULSI | processing | |
| | incorporated. A 50 μm | Very low power | Pigmented inks | |
| | long PTFE | consumption | may be infeasible, | |
| | bend actuator with | Many ink types | as pigment | |
| | polysilicon heater | can be used | particles may jam | |
| | and 15 mW power | Simple planar | the bend actuator | |
| | input can provide | fabrication | | |
| | 180 μN force and | Small chip area | | |
| | 10 μm deflection. | required for each | | |
| | Actuator motions | actuator | | |
| | include: | Fast operation | | |
| | Bend | High efficiency | | |
| | Push | CMOS compatible | | |
| | Buckle | voltages and | | |
| | Rotate | currents | | |
| | | Easy extension | | |
| | | from single | | |
| | | nozzles to | | |
| | | pagewidth print | | |
| | | heads | | |
| Conductive | A polymer with a | High force can be | Requires special | IJ24 |
| polymer | high coefficient of | generated | materials | |
| thermo- | thermal expansion | Very low power | development | |
| elastic | (such as PTFE) is | consumption | (High CTE | |
| actuator | doped with | Many ink types | conductive | |
| | conducting | can be used | polymer) | |
| | substances to | Simple planar | Requires a PTFE | |
| | increase its | fabrication | deposition process, | |
| | conductivity to | Small chip area | which is not yet | |
| | about 3 orders of | required for each | standard in ULSI | |
| | magnitude below | actuator | fabs | |
| | that of copper. The | Fast operation | PTFE deposition | |
| | conducting | High efficiency | cannot be followed | |
| | polymer expands | CMOS compatible | with high | |
| | when resistively | voltages and | temperature | |
| | heated. | currents | (above 350° C.) | |
| | Examples of | Easy extension | processing | |
| | conducting | from single | Evaporation and | |
| | dopants include: | nozzles to | CVD deposition | |
| | Carbon nanotubes | pagewidth print | techniques cannot | |
| | Metal fibers | heads | be used | |
| | Conductive | | Pigmented inks | |
| | polymers such as | | may be infeasible, | |
| | doped | | as pigment | |
| | polythiophene | | particles may jam | |
| | Carbon granules | | the bend actuator | |
| Shape | A shape memory | High force is | Fatigue limits | IJ26 |
| memory | alloy such as TiNi | available (stresses | maximum number | |
| alloy | (also known as | of hundreds of | of cycles | |
| | Nitinol —Nickel | MPa) | Low strain (1%) is | |
| | Titanium alloy | Large strain is | required to extend | |
| | developed at the | available (more | fatigue resistance | |
| | Naval Ordnance | than 3%) | Cycle rate limited | |
| | Laboratory) is | High corrosion | by heat removal | |
| | thermally switched | resistance | Requires unusual | |
| | between its weak | Simple | materials (TiNi) | |
| | martensitic state | construction | The latent heat of | |
| | and its high | Easy extension | transformation | |
| | stiffness austenic | from single | must be provided | |
| | state. The shape of | nozzles to | High current | |
| | the actuator in its | pagewidth print | operation | |
| | martensitic state is | heads | Requires pre- | |
| | deformed relative | Low voltage | stressing to distort | |
| | to the austenic | operation | the martensitic | |
| | shape. The shape | | state | |
| | change causes | | | |
| | ejection of a drop. | | | |
| Linear | Linear magnetic | Linear Magnetic | Requires unusual | IJ12 |
| Magnetic | actuators include | actuators can be | semiconductor | |
| Actuator | the Linear | constructed with | materials such as | |
| | Induction Actuator | high thrust, long | soft magnetic | |
| | (LIA), Linear | travel, and high | alloys (e.g. | |
| | Permanent Magnet | efficiency using | CoNiFe) | |
| | Synchronous | planar | Some varieties | |
| | Actuator | semiconductor | also require | |
| | (LPMSA), Linear | fabrication | permanent | |
| | Reluctance | techniques | magnetic materials | |
| | Synchronous | Long actuator | such as | |
| | Actuator (LRSA), | travel is available | Neodymium iron | |
| | Linear Switched | Medium force is | boron (NdFeB) | |
| | Reluctance | available | Requires complex | |
| | Actuator (LSRA), | Low voltage | multi-phase drive | |
| | and the Linear | operation | circuitry | |
| | Stepper Actuator | | High current | |
| | (LSA). | | operation | |

Basic operation mode

| | Description | Advantages | Disadvantages | Examples |
|---|---|---|---|---|
| Actuator | This is the | Simple operation | Drop repetition | Thermal ink jet |
| directly | simplest mode of | No external fields | rate is usually | Piezoelectric ink |
| pushes ink | operation: the | required | limited to around | jet |
| | actuator directly | Satellite drops can | 10 kHz. However, | IJ01, IJ02, IJ03, |
| | supplies sufficient | be avoided if drop | this is not | IJ04, IJ05, IJ06, |
| | kinetic energy to | velocity is less | fundamental to the | IJ07, IJ09, IJ11, |
| | expel the drop. | than 4 m/s | method, but is | IJ12, IJ14, IJ16, |
| | The drop must | Can be efficient, | related to the refill | IJ20, IJ22, IJ23, |
| | have a sufficient | depending upon | method normally | IJ24, IJ25, IJ26, |
| | velocity to | the actuator used | used | IJ27, IJ28, IJ29, |
| | overcome the | | All of the drop | IJ30, IJ31, IJ32, |
| | surface tension. | | kinetic energy | IJ33, IJ34, IJ35, |
| | | | must be provided | IJ36, IJ37, IJ38, |
| | | | by the actuator | IJ39, IJ40, IJ41, |
| | | | Satellite drops | IJ42, IJ43, IJ44 |
| | | | usually form if | |
| | | | drop velocity is | |
| | | | greater than 4.5 m/s | |
| Proximity | The drops to be | Very simple print | Requires close | Silverbrook, EP |
| | printed are | head fabrication | proximity between | 0771 658 A2 and |
| | selected by some | can be used | the print head and | related patent |
| | manner (e.g. | The drop selection | the print media or | applications |
| | thermally induced | means does not | transfer roller | |
| | surface tension | need to provide the | May require two | |
| | reduction of | energy required to | print heads | |
| | pressurized ink). | separate the drop | printing alternate | |
| | Selected drops are | from the nozzle | rows of the image | |
| | separated from the | | Monolithic color | |
| | ink in the nozzle | | print heads are | |
| | by contact with the | | difficult | |
| | print medium or a | | | |
| | transfer roller. | | | |
| Electrostatic | The drops to be | Very simple print | Requires very high | Silverbrook, EP |
| pull | printed are | head fabrication | electrostatic field | 0771 658 A2 and |
| on ink | selected by some | can be used | Electrostatic field | related patent |
| | manner (e.g. | The drop selection | for small nozzle | applications |
| | thermally induced | means does not | sizes is above air | Tone-Jet |
| | surface tension | need to provide the | breakdown | |
| | reduction of | energy required to | Electrostatic field | |
| | pressurized ink). | separate the drop | may attract dust | |
| | Selected drops are | from the nozzle | | |
| | separated from the | | | |
| | ink in the nozzle | | | |
| | by a strong electric | | | |
| | field. | | | |
| Magnetic | The drops to be | Very simple print | Requires magnetic | Silverbrook, EP |
| pull on ink | printed are | head fabrication | ink | 0771 658 A2 and |
| | selected by some | can be used | Ink colors other | related patent |
| | manner (e.g. | The drop selection | than black are | applications |
| | thermally induced | means does not | difficult | |
| | surface tension | need to provide the | Requires very high | |
| | reduction of | energy required to | magnetic fields | |
| | pressurized ink). | separate the drop | | |
| | Selected drops are | from the nozzle | | |
| | separated from the | | | |
| | ink in the nozzle | | | |
| | by a strong | | | |
| | magnetic field | | | |
| | acting on the | | | |
| | magnetic ink. | | | |
| Shutter | The actuator | High speed (>50 kHz) | Moving parts are | IJ13, IJ17, IJ21 |
| | moves a shutter to | operation can | required | |
| | block ink flow to | be achieved due to | Requires ink | |
| | the nozzle. The ink | reduced refill time | pressure modulator | |
| | pressure is pulsed | Drop timing can | Friction and wear | |
| | at a multiple of the | be very accurate | must be considered | |
| | drop ejection | The actuator | Stiction is possible | |
| | frequency. | energy can be very | | |
| | | low | | |
| Shuttered | The actuator | Actuators with | Moving parts are | IJ08, IJ15, IJ18, |
| grill | moves a shutter to | small travel can be | required | IJ19 |
| | block ink flow | used | Requires ink | |
| | through a grill to | Actuators with | pressure modulator | |
| | the nozzle. The | small force can be | Friction and wear | |
| | shutter movement | used | must be considered | |
| | need only be equal | High speed (>50 kHz) | Stiction is possible | |
| | to the width of the | operation can | | |
| | grill holes. | be achieved | | |
| Pulsed | A pulsed magnetic | Extremely low | Requires an | IJ10 |
| magnetic | field attracts an | energy operation is | external pulsed | |
| pull on ink | ‘ink pusher’ at the | possible | magnetic field | |
| pusher | drop ejection | No heat dissipation | Requires special | |
| | frequency. An | problems | materials for both | |
| | actuator controls a | | the actuator and | |
| | catch, which | | the ink pusher | |
| | prevents the ink | | Complex | |
| | pusher from | | construction | |
| | moving when a | | | |
| | drop is not to be | | | |
| | ejected. | | | |

Auxiliary mechanism (applied to all nozzles)

| | Description | Advantages | Disadvantages | Examples |
|---|---|---|---|---|
| None | The actuator | Simplicity of | Drop ejection | Most ink jets, |
| | directly fires the | construction | energy must be | including |
| | ink drop, and there | Simplicity of | supplied by | piezoelectric and |
| | is no external field | operation | individual nozzle | thermal bubble. |
| | or other | Small physical size | actuator | IJ01, IJ02, IJ03, |
| | mechanism | | | IJ04, IJ05, IJ07, |
| | required. | | | IJ09, IJ11, IJ12, |
| | | | | IJ14, IJ20, IJ22, |
| | | | | IJ23, IJ24, IJ25, |
| | | | | IJ26, IJ27, IJ28, |
| | | | | IJ29, IJ30, IJ31, |
| | | | | IJ32, IJ33, IJ34, |
| | | | | IJ35, IJ36, IJ37, |
| | | | | IJ38, IJ39, IJ40, |
| | | | | IJ41, IJ42, IJ43, |
| | | | | IJ44 |
| Oscillating | The ink pressure | Oscillating ink | Requires external | Silverbrook, EP |
| ink | oscillates, | pressure can | ink pressure | 0771 658 A2 and |
| pressure | providing much of | provide a refill | oscillator | related patent |
| (including | the drop ejection | pulse, allowing | Ink pressure phase | applications |
| acoustic | energy. The | higher operating | and amplitude | IJ08, IJ13, IJ15, |
| stimulation) | actuator selects | speed | must be carefully | IJ17, IJ18, IJ19, |
| | which drops are to | The actuators may | controlled | IJ21 |
| | be fired by | operate with much | Acoustic | |
| | selectively | lower energy | reflections in the | |
| | blocking or | Acoustic lenses | ink chamber must | |
| | enabling nozzles. | can be used to | be designed for | |
| | The ink pressure | focus the sound on | | |
| | oscillation may be | the nozzles | | |
| | achieved by | | | |
| | vibrating the print | | | |
| | head, or preferably | | | |
| | by an actuator in | | | |
| | the ink supply. | | | |
| Media | The print head is | Low power | Precision assembly | Silverbrook, EP |
| proximity | placed in close | High accuracy | required | 0771 658 A2 and |
| | proximity to the | Simple print head | Paper fibers may | related patent |
| | print medium. | construction | cause problems | applications |
| | Selected drops | | Cannot print on | |
| | protrude from the | | rough substrates | |
| | print head further | | | |
| | than unselected | | | |
| | drops, and contact | | | |
| | the print medium. | | | |
| | The drop soaks | | | |
| | into the medium | | | |
| | fast enough to | | | |
| | cause drop | | | |
| | separation. | | | |
| Transfer | Drops are printed | High accuracy | Bulky | Silverbrook, EP |
| roller | to a transfer roller | Wide range of | Expensive | 0771 658 A2 and |
| | instead of straight | print substrates can | Complex | related patent |
| | to the print | be used | construction | applications |
| | medium. A | Ink can be dried on | | Tektronix hot melt |
| | transfer roller can | the transfer roller | | piezoelectric ink |
| | also be used for | | | jet |
| | proximity drop | | | Any of the IJ |
| | separation. | | | series |
| Electrostatic | An electric field is | Low power | Field strength | Silverbrook, EP |
| | used to accelerate | Simple print head | required for | 0771 658 A2 and |
| | selected drops | construction | separation of small | related patent |
| | towards the print | | drops is near or | applications |
| | medium. | | above air | Tone-Jet |
| | | | breakdown | |
| Direct | A magnetic field is | Low power | Requires magnetic | Silverbrook, EP |
| magnetic | used to accelerate | Simple print head | ink | 0771 658 A2 and |
| field | selected drops of | construction | Requires strong | related patent |
| | magnetic ink | | magnetic field | applications |
| | towards the print | | | |
| | medium. | | | |
| Cross | The print head is | Does not require | Requires external | IJ06, IJ16 |
| magnetic | placed in a | magnetic materials | magnet | |
| field | constant magnetic | to be integrated in | Current densities | |
| | field. The Lorenz | the print head | may be high, | |
| | force in a current | manufacturing | resulting in | |
| | carrying wire is | process | electromigration | |
| | used to move the | | problems | |
| | actuator. | | | |
| Pulsed | A pulsed magnetic | Very low power | Complex print | IJ10 |
| magnetic | field is used to | operation is | head construction | |
| field | cyclically attract a | possible | Magnetic materials | |
| | paddle, which | Small print head | required in print | |
| | pushes on the ink. | size | head | |
| | A small actuator | | | |
| | moves a catch, | | | |
| | which selectively | | | |
| | prevents the | | | |
| | paddle from | | | |
| | moving. | | | |

Actuator amplification or modification method

| | Description | Advantages | Disadvantages | Examples |
|---|---|---|---|---|
| None | No actuator | Operational | Many actuator | Thermal Bubble |
| | mechanical | simplicity | mechanisms have | Ink jet |
| | amplification is | | insufficient travel, | IJ01, IJ02, IJ06, |
| | used. The actuator | | or insufficient | IJ07, IJ16, IJ25, |
| | directly drives the | | force, to efficiently | IJ26 |
| | drop ejection | | drive the drop | |
| | process. | | ejection process | |
| Differential | An actuator | Provides greater | High stresses are | Piezoelectric |
| expansion | material expands | travel in a reduced | involved | IJ03, IJ09, IJ17, |
| bend | more on one side | print head area | Care must be taken | IJ18, IJ19, IJ20, |
| actuator | than on the other. | | that the materials | IJ21, IJ22, IJ23, |
| | The expansion | | do not delaminate | IJ24, IJ27, IJ29, |
| | may be thermal, | | Residual bend | IJ30, IJ31, IJ32, |
| | piezoelectric, | | resulting from high | IJ33, IJ34, IJ35, |
| | magnetostrictive, | | temperature or | IJ36, IJ37, IJ38, |
| | or other | | high stress during | IJ39, IJ42, IJ43, |
| | mechanism. The | | formation | IJ44 |
| | bend actuator | | | |
| | converts a high | | | |
| | force low travel | | | |
| | actuator | | | |
| | mechanism to high | | | |
| | travel, lower force | | | |
| | mechanism. | | | |
| Transient | A trilayer bend | Very good | High stresses are | IJ40, IJ41 |
| bend | actuator where the | temperature | involved | |
| actuator | two outside layers | stability | Care must be taken | |
| | are identical. This | High speed, as a | that the materials | |
| | cancels bend due | new drop can be | do not delaminate | |
| | to ambient | fired before heat | | |
| | temperature and | dissipates | | |
| | residual stress. The | Cancels residual | | |
| | actuator only | stress of formation | | |
| | responds to | | | |
| | transient heating of | | | |
| | one side or the | | | |
| | other. | | | |
| Reverse | The actuator loads | Better coupling to | Fabrication | IJ05, IJ11 |
| spring | a spring. When the | the ink | complexity | |
| | actuator is turned | | High stress in the | |
| | off, the spring | | spring | |
| | releases. This can | | | |
| | reverse the | | | |
| | force/distance | | | |
| | curve of the | | | |
| | actuator to make it | | | |
| | compatible with | | | |
| | the force/time | | | |
| | requirements of | | | |
| | the drop ejection. | | | |
| Actuator | A series of thin | Increased travel | Increased | Some piezoelectric |
| stack | actuators are | Reduced drive | fabrication | ink jets |
| | stacked. This can | voltage | complexity | IJ04 |
| | be appropriate | | Increased | |
| | where actuators | | possibility of short | |
| | require high | | circuits due to | |
| | electric field | | pinholes | |
| | strength, such as | | | |
| | electrostatic and | | | |
| | piezoelectric | | | |
| | actuators. | | | |
| Multiple | Multiple smaller | Increases the force | Actuator forces | IJ12, IJ13, IJ18, |
| actuators | actuators are used | available from an | may not add | IJ20, IJ22, IJ28, |
| | simultaneously to | actuator | linearly, reducing | IJ42, IJ43 |
| | move the ink. Each | Multiple actuators | efficiency | |
| | actuator need | can be positioned | | |
| | provide only a | to control ink flow | | |
| | portion of the | accurately | | |
| | force required. | | | |
| Linear | A linear spring is | Matches low travel | Requires print | IJ15 |
| Spring | used to transform a | actuator with | head area for the | |
| | motion with small | higher travel | spring | |
| | travel and high | requirements | | |
| | force into a longer | Non-contact | | |
| | travel, lower force | method of motion | | |
| | motion. | transformation | | |
| Coiled | A bend actuator is | Increases travel | Generally | IJ17, IJ21, IJ34, |
| actuator | coiled to provide | Reduces chip area | restricted to planar | IJ35 |
| | greater travel in a | Planar | implementations | |
| | reduced chip area. | implementations | due to extreme | |
| | | are relatively easy | fabrication | |
| | | to fabricate. | difficulty in other | |
| | | | orientations. | |
| Flexure | A bend actuator | Simple means of | Care must be taken | IJ10, IJ19, IJ33 |
| bend | has a small region | increasing travel of | not to exceed the | |
| actuator | near the fixture | a bend actuator | elastic limit in the | |
| | point, which flexes | | flexure area | |
| | much more readily | | Stress distribution | |
| | than the remainder | | is very uneven | |
| | of the actuator. | | Difficult to | |
| | The actuator | | accurately model | |
| | flexing is | | with finite element | |
| | effectively | | analysis | |
| | converted from an | | | |
| | even coiling to an | | | |
| | angular bend, | | | |
| | resulting in greater | | | |
| | travel of the | | | |
| | actuator tip. | | | |
| Catch | The actuator | Very low actuator | Complex | IJ10 |
| | controls a small | energy | construction | |
| | catch. The catch | Very small | Requires external | |
| | either enables or | actuator size | force | |
| | disables movement | | Unsuitable for | |
| | of an ink pusher | | pigmented inks | |
| | that is controlled | | | |
| | in a bulk manner. | | | |
| Gears | Gears can be used | Low force, low | Moving parts are | IJ13 |
| | to increase travel | travel actuators | required | |
| | at the expense of | can be used | Several actuator | |
| | duration. Circular | Can be fabricated | cycles are required | |
| | gears, rack and | using standard | More complex | |
| | pinion, ratchets, | surface MEMS | drive electronics | |
| | and other gearing | processes | Complex | |
| | methods can be | | construction | |
| | used. | | Friction, friction, | |
| | | | and wear are | |
| | | | possible | |
| Buckle | A buckle plate can | Very fast | Must stay within | S. Hirata et al, “An |
| plate | be used to change | movement | elastic limits of the | Ink-jet Head Using |
| | a slow actuator | achievable | materials for long | Diaphragm |
| | into a fast motion. | | device life | Microactuator”, |
| | It can also convert | | High stresses | Proc. IEEE |
| | a high force, low | | involved | MEMS, February 1996, |
| | travel actuator into | | Generally high | pp 418-423. |
| | a high travel, | | power requirement | IJ18, IJ27 |
| | medium force | | | |
| | motion. | | | |
| Tapered | A tapered | Linearizes the | Complex | IJ14 |
| magnetic | magnetic pole can | magnetic | construction | |
| pole | increase travel at | force/distance | | |
| | the expense of | curve | | |
| | force. | | | |
| Lever | A lever and | Matches low travel | High stress around | IJ32, IJ36, IJ37 |
| | fulcrum is used to | actuator with | the fulcrum | |
| | transform a motion | higher travel | | |
| | with small travel | requirements | | |
| | and high force into | Fulcrum area has | | |
| | a motion with | no linear | | |
| | longer travel and | movement, and | | |
| | lower force. The | can be used for a | | |
| | lever can also | fluid seal | | |
| | reverse the | | | |
| | direction of travel. | | | |
| Rotary | The actuator is | High mechanical | Complex | IJ28 |
| impeller | connected to a | advantage | construction | |
| | rotary impeller. A | The ratio of force | Unsuitable for | |
| | small angular | to travel of the | pigmented inks | |
| | deflection of the | actuator can be | | |
| | actuator results in | matched to the | | |
| | a rotation of the | nozzle | | |
| | impeller vanes, | requirements by | | |
| | which push the ink | varying the | | |
| | against stationary | number of impeller | | |
| | vanes and out of | vanes | | |
| | the nozzle. | | | |
| Acoustic | A refractive or | No moving parts | Large area | 1993 Hadimioglu |
| lens | diffractive (e.g. | | required | et al, EUP 550,192 |
| | zone plate) | | Only relevant for | 1993 Elrod et al, |
| | acoustic lens is | | acoustic ink jets | EUP 572,220 |
| | used to concentrate | | | |
| | sound waves. | | | |
| Sharp | A sharp point is | Simple | Difficult to | Tone-jet |
| conductive | used to concentrate | construction | fabricate using | |
| point | an electrostatic | | standard VLSI | |
| | field. | | processes for a | |
| | | | surface ejecting | |
| | | | ink-jet | |
| | | | Only relevant for | |
| | | | electrostatic ink | |
| | | | jets | |

Actuator motion

| | Description | Advantages | Disadvantages | Examples |
|---|---|---|---|---|
| Volume | The volume of the | Simple | High energy is | Hewlett-Packard |
| expansion | actuator changes, | construction in the | typically required | Thermal Ink jet |
| | pushing the ink in | case of thermal ink | to achieve volume | Canon Bubblejet |
| | all directions. | jet | expansion. This | |
| | | | leads to thermal | |
| | | | stress, cavitation, | |
| | | | and kogation in | |
| | | | thermal ink jet | |
| | | | implementations | |
| Linear, | The actuator | Efficient coupling | High fabrication | IJ01, IJ02, IJ04, |
| normal to | moves in a | to ink drops | complexity may be | IJ07, IJ11, IJ14 |
| chip | direction normal to | ejected normal to | required to achieve | |
| surface | the print head | the surface | perpendicular | |
| | surface. The | | motion | |
| | nozzle is typically | | | |
| | in the line of | | | |
| | movement. | | | |
| Parallel to | The actuator | Suitable for planar | Fabrication | IJ12, IJ13, IJ15, |
| chip | moves parallel to | fabrication | complexity | IJ33,, IJ34, IJ35, |
| surface | the print head | | Friction | IJ36 |
| | surface. Drop | | Stiction | |
| | ejection may still | | | |
| | be normal to the | | | |
| | surface. | | | |
| Membrane | An actuator with a | The effective area | Fabrication | 1982 Howkins |
| push | high force but | of the actuator | complexity | U.S. Pat. No. 4,459,601 |
| | small area is used | becomes the | Actuator size | |
| | to push a stiff | membrane area | Difficulty of | |
| | membrane that is | | integration in a | |
| | in contact with the | | VLSI process | |
| | ink. | | | |
| Rotary | The actuator | Rotary levers may | Device complexity | IJ05, IJ08, IJ13, |
| | causes the rotation | be used to increase | May have friction | IJ28 |
| | of some element, | travel | at a pivot point | |
| | such a grill or | Small chip area | | |
| | impeller | requirements | | |
| Bend | The actuator bends | A very small | Requires the | 1970 Kyser et al |
| | when energized. | change in | actuator to be | U.S. Pat. No. 3,946,398 |
| | This may be due to | dimensions can be | made from at least | 1973 Stemme U.S. Pat. No. |
| | differential | converted to a | two distinct layers, | 3,747,120 |
| | thermal expansion, | large motion. | or to have a | IJ03, IJ09, IJ10, |
| | piezoelectric | | thermal difference | IJ19, IJ23, IJ24, |
| | expansion, | | across the actuator | IJ25, IJ29, IJ30, |
| | magnetostriction, | | | IJ31, IJ33, IJ34, |
| | or other form of | | | IJ35 |
| | relative | | | |
| | dimensional | | | |
| | change. | | | |
| Swivel | The actuator | Allows operation | Inefficient | IJ06 |
| | swivels around a | where the net | coupling to the ink | |
| | central pivot. This | linear force on the | motion | |
| | motion is suitable | paddle is zero | | |
| | where there are | Small chip area | | |
| | opposite forces | requirements | | |
| | applied to opposite | | | |
| | sides of the paddle, | | | |
| | e.g. Lorenz force. | | | |
| Straighten | The actuator is | Can be used with | Requires careful | IJ26, IJ32 |
| | normally bent, and | shape memory | balance of stresses | |
| | straightens when | alloys where the | to ensure that the | |
| | energized. | austenic phase is | quiescent bend is | |
| | | planar | accurate | |
| Double | The actuator bends | One actuator can | Difficult to make | IJ36, IJ37, IJ38 |
| bend | in one direction | be used to power | the drops ejected | |
| | when one element | two nozzles. | by both bend | |
| | is energized, and | Reduced chip size. | directions | |
| | bends the other | Not sensitive to | identical. | |
| | way when another | ambient | A small efficiency | |
| | element is | temperature | loss compared to | |
| | energized. | | equivalent single | |
| | | | bend actuators. | |
| Shear | Energizing the | Can increase the | Not readily | 1985 Fishbeck |
| | actuator causes a | effective travel of | applicable to other | U.S. Pat. No. 4,584,590 |
| | shear motion in the | piezoelectric | actuator | |
| | actuator material. | actuators | mechanisms | |
| Radial | The actuator | Relatively easy to | High force | 1970 Zoltan U.S. Pat. No. |
| constriction | squeezes an ink | fabricate single | required | 3,683,212 |
| | reservoir, forcing | nozzles from glass | Inefficient | |
| | ink from a | tubing as | Difficult to | |
| | constricted nozzle. | macroscopic | integrate with | |
| | | structures | VLSI processes | |
| Coil/ | A coiled actuator | Easy to fabricate | Difficult to | IJ17, IJ21, IJ34, |
| uncoil | uncoils or coils | as a planar VLSI | fabricate for non- | IJ35 |
| | more tightly. The | process | planar devices | |
| | motion of the free | Small area | Poor out-of-plane | |
| | end of the actuator | required, therefore | stiffness | |
| | ejects the ink. | low cost | | |
| Bow | The actuator bows | Can increase the | Maximum travel is | IJ16, IJ18, IJ27 |
| | (or buckles) in the | speed of travel | constrained | |
| | middle when | Mechanically rigid | High force | |
| | energized. | | required | |
| Push-Pull | Two actuators | The structure is | Not readily | IJ18 |
| | control a shutter. | pinned at both | suitable for ink jets | |
| | One actuator pulls | ends, so has a high | which directly | |
| | the shutter, and the | out-of-plane | push the ink | |
| | other pushes it. | rigidity | | |
| Curl | A set of actuators | Good fluid flow to | Design complexity | IJ20, IJ42 |
| inwards | curl inwards to | the region behind | | |
| | reduce the volume | the actuator | | |
| | of ink that they | increases | | |
| | enclose. | efficiency | | |
| Curl | A set of actuators | Relatively simple | Relatively large | IJ43 |
| outwards | curl outwards, | construction | chip area | |
| | pressurizing ink in | | | |
| | a chamber | | | |
| | surrounding the | | | |
| | actuators, and | | | |
| | expelling ink from | | | |
| | a nozzle in the | | | |
| | chamber. | | | |
| Iris | Multiple vanes | High efficiency | High fabrication | IJ22 |
| | enclose a volume | Small chip area | complexity | |
| | of ink. These | | Not suitable for | |
| | simultaneously | | pigmented inks | |
| | rotate, reducing | | | |
| | the volume | | | |
| | between the vanes. | | | |
| Acoustic | The actuator | The actuator can | Large area | 1993 Hadimioglu |
| vibration | vibrates at a high | be physically | required for | et al, EUP 550,192 |
| | frequency. | distant from the | efficient operation | 1993 Elrod et al, |
| | | ink | at useful | EUP 572,220 |
| | | | frequencies | |
| | | | Acoustic coupling | |
| | | | and crosstalk | |
| | | | Complex drive | |
| | | | circuitry | |
| | | | Poor control of | |
| | | | drop volume and | |
| | | | position | |
| None | In various ink jet | No moving parts | Various other | Silverbrook, EP |
| | designs the | | tradeoffs are | 0771 658 A2 and |
| | actuator does not | | required to | related patent |
| | move. | | eliminate moving | applications |
| | | | parts | Tone-jet |

Nozzle refill method

| | Description | Advantages | Disadvantages | Examples |
|---|---|---|---|---|
| Surface | This is the normal | Fabrication | Low speed | Thermal ink jet |
| tension | way that ink jets | simplicity | Surface tension | Piezoelectric ink |
| | are refilled. After | Operational | force relatively | jet |
| | the actuator is | simplicity | small compared to | IJ01-IJ07, IJ10-IJ14, |
| | energized, it | | actuator force | IJ16, IJ20, |
| | typically returns | | Long refill time | IJ22-IJ45 |
| | rapidly to its | | usually dominates | |
| | normal position. | | the total repetition | |
| | This rapid return | | rate | |
| | sucks in air | | | |
| | through the nozzle | | | |
| | opening. The ink | | | |
| | surface tension at | | | |
| | the nozzle then | | | |
| | exerts a small | | | |
| | force restoring the | | | |
| | meniscus to a | | | |
| | minimum area. | | | |
| | This force refills | | | |
| | the nozzle. | | | |
| Shuttered | Ink to the nozzle | High speed | Requires common | IJ08, IJ13, IJ15, |
| oscillating | chamber is | Low actuator | ink pressure | IJ17, IJ18, IJ19, |
| ink | provided at a | energy, as the | oscillator | IJ21 |
| pressure | pressure that | actuator need only | May not be | |
| | oscillates at twice | open or close the | suitable for | |
| | the drop ejection | shutter, instead of | pigmented inks | |
| | frequency. When a | ejecting the ink | | |
| | drop is to be | drop | | |
| | ejected, the shutter | | | |
| | is opened for 3 | | | |
| | half cycles: drop | | | |
| | ejection, actuator | | | |
| | return, and refill. | | | |
| | The shutter is then | | | |
| | closed to prevent | | | |
| | the nozzle | | | |
| | chamber emptying | | | |
| | during the next | | | |
| | negative pressure | | | |
| | cycle. | | | |
| Refill | After the main | High speed, as the | Requires two | IJ09 |
| actuator | actuator has | nozzle is actively | independent | |
| | ejected a drop a | refilled | actuators per | |
| | second (refill) | | nozzle | |
| | actuator is | | | |
| | energized. The | | | |
| | refill actuator | | | |
| | pushes ink into the | | | |
| | nozzle chamber. | | | |
| | The refill actuator | | | |
| | returns slowly, to | | | |
| | prevent its return | | | |
| | from emptying the | | | |
| | chamber again. | | | |
| Positive | The ink is held a | High refill rate, | Surface spill must | Silverbrook, EP |
| ink | slight positive | therefore a high | be prevented | 0771 658 A2 and |
| pressure | pressure. After the | drop repetition rate | Highly | related patent |
| | ink drop is ejected, | is possible | hydrophobic print | applications |
| | the nozzle | | head surfaces are | Alternative for:, |
| | chamber fills | | required | IJ01-IJ07, IJ10-IJ14, |
| | quickly as surface | | | IJ16, IJ20, |
| | tension and ink | | | IJ22-IJ45 |
| | pressure both | | | |
| | operate to refill the | | | |
| | nozzle. | | | |

Method of restricting back-flow through inlet

| | Description | Advantages | Disadvantages | Examples |
|---|---|---|---|---|
| Long inlet | The ink inlet | Design simplicity | Restricts refill rate | Thermal ink jet |
| channel | channel to the | Operational | May result in a | Piezoelectric ink |
| | nozzle chamber is | simplicity | relatively large | jet |
| | made long and | Reduces crosstalk | chip area | IJ42, IJ43 |
| | relatively narrow, | | Only partially | |
| | relying on viscous | | effective | |
| | drag to reduce | | | |
| | inlet back-flow. | | | |
| Positive | The ink is under a | Drop selection and | Requires a method | Silverbrook, EP |
| ink | positive pressure, | separation forces | (such as a nozzle | 0771 658 A2 and |
| pressure | so that in the | can be reduced | rim or effective | related patent |
| | quiescent state | Fast refill time | hydrophobizing, or | applications |
| | some of the ink | | both) to prevent | Possible operation |
| | drop already | | flooding of the | of the following: |
| | protrudes from the | | ejection surface of | IJ01-IJ07, IJ09-IJ12, |
| | nozzle. | | the print head. | IJ14, IJ16, |
| | This reduces the | | | IJ20, IJ22, IJ23-IJ34, |
| | pressure in the | | | IJ36-IJ41, |
| | nozzle chamber | | | IJ44 |
| | which is required | | | |
| | to eject a certain | | | |
| | volume of ink. The | | | |
| | reduction in | | | |
| | chamber pressure | | | |
| | results in a | | | |
| | reduction in ink | | | |
| | pushed out through | | | |
| | the inlet. | | | |
| Baffle | One or more | The refill rate is | Design complexity | HP Thermal Ink |
| | baffles are placed | not as restricted as | May increase | Jet |
| | in the inlet ink | the long inlet | fabrication | Tektronix |
| | flow. When the | method. | complexity (e.g. | piezoelectric ink |
| | actuator is | Reduces crosstalk | Tektronix hot melt | jet |
| | energized, the | | Piezoelectric print | |
| | rapid ink | | heads). | |
| | movement creates | | | |
| | eddies which | | | |
| | restrict the flow | | | |
| | through the inlet. | | | |
| | The slower refill | | | |
| | process is | | | |
| | unrestricted, and | | | |
| | does not result in | | | |
| | eddies. | | | |
| Flexible | In this method | Significantly | Not applicable to | Canon |
| flap | recently disclosed | reduces back-flow | most ink jet | |
| restricts | by Canon, the | for edge-shooter | configurations | |
| inlet | expanding actuator | thermal ink jet | Increased | |
| | (bubble) pushes on | devices | fabrication | |
| | a flexible flap that | | complexity | |
| | restricts the inlet. | | Inelastic | |
| | | | deformation of | |
| | | | polymer flap | |
| | | | results in creep | |
| | | | over extended use | |
| Inlet filter | A filter is located | Additional | Restricts refill rate | IJ04, IJ12, IJ24, |
| | between the ink | advantage of ink | May result in | IJ27, IJ29, IJ30 |
| | inlet and the | filtration | complex | |
| | nozzle chamber. | Ink filter may be | construction | |
| | The filter has a | fabricated with no | | |
| | multitude of small | additional process | | |
| | holes or slots, | steps | | |
| | restricting ink | | | |
| | flow. The filter | | | |
| | also removes | | | |
| | particles which | | | |
| | may block the | | | |
| | nozzle. | | | |
| Small inlet | The ink inlet | Design simplicity | Restricts refill rate | IJ02, IJ37, IJ44 |
| compared | channel to the | | May result in a | |
| to nozzle | nozzle chamber | | relatively large | |
| | has a substantially | | chip area | |
| | smaller cross | | Only partially | |
| | section than that of | | effective | |
| | the nozzle, | | | |
| | resulting in easier | | | |
| | ink egress out of | | | |
| | the nozzle than out | | | |
| | of the inlet. | | | |
| Inlet | A secondary | Increases speed of | Requires separate | IJ09 |
| shutter | actuator controls | the ink-jet print | refill actuator and | |
| | the position of a | head operation | drive circuit | |
| | shutter, closing off | | | |
| | the ink inlet when | | | |
| | the main actuator | | | |
| | is energized. | | | |
| The inlet | The method avoids | Back-flow | Requires careful | IJ01, IJ03, 1J05, |
| is located | the problem of | problem is | design to minimize | IJ06, IJ07, IJ10, |
| behind the | inlet back-flow by | eliminated | the negative | IJ11, IJ14, IJ16, |
| ink- | arranging the ink- | | pressure behind | IJ22, IJ23, IJ25, |
| pushing | pushing surface of | | the paddle | IJ28, IJ31, IJ32, |
| surface | the actuator | | | IJ33, IJ34, IJ35, |
| | between the inlet | | | IJ36, IJ39, IJ40, |
| | and the nozzle. | | | IJ41 |
| Part of the | The actuator and a | Significant | Small increase in | IJ07, IJ20, IJ26, |
| actuator | wall of the ink | reductions in back- | fabrication | IJ38 |
| moves to | chamber are | flow can be | complexity | |
| shut off | arranged so that | achieved | | |
| the inlet | the motion of the | Compact designs | | |
| | actuator closes off | possible | | |
| | the inlet. | | | |
| Nozzle | In some | Ink back-flow | None related to ink | Silverbrook, EP |
| actuator | configurations of | problem is | back-flow on | 0771 658 A2 and |
| does not | ink jet, there is no | eliminated | actuation | related patent |
| result in | expansion or | | | applications |
| ink back- | movement of an | | | Valve-jet |
| flow | actuator which | | | Tone-jet |
| | may cause ink | | | |
| | back-flow through | | | |
| | the inlet. | | | |

Nozzle Clearing Method

| | Description | Advantages | Disadvantages | Examples |
|---|---|---|---|---|
| Normal | All of the nozzles | No added | May not be | Most ink jet |
| nozzle | are fired | complexity on the | sufficient to | systems |
| firing | periodically, | print head | displace dried ink | IJ01, IJ02, IJ03, |
| | before the ink has | | | IJ04, IJ05, IJ06, |
| | a chance to dry. | | | IJ07, IJ09, IJ10, |
| | When not in use | | | IJ11, IJ12, IJ14, |
| | the nozzles are | | | IJ16, IJ20, IJ22, |
| | sealed (capped) | | | IJ23, IJ24, IJ25, |
| | against air. | | | IJ26, IJ27, IJ28, |
| | The nozzle firing | | | IJ29, IJ30, IJ31, |
| | is usually | | | IJ32, IJ33, IJ34, |
| | performed during a | | | IJ36, IJ37, IJ38, |
| | special clearing | | | IJ39, IJ40,, IJ41, |
| | cycle, after first | | | IJ42, IJ43, IJ44,, |
| | moving the print | | | IJ45 |
| | head to a cleaning | | | |
| | station. | | | |
| Extra | In systems which | Can be highly | Requires higher | Silverbrook, EP |
| power to | heat the ink, but do | effective if the | drive voltage for | 0771 658 A2 and |
| ink heater | not boil it under | heater is adjacent | clearing | related patent |
| | normal situations, | to the nozzle | May require larger | applications |
| | nozzle clearing can | | drive transistors | |
| | be achieved by | | | |
| | over-powering the | | | |
| | heater and boiling | | | |
| | ink at the nozzle. | | | |
| Rapid | The actuator is | Does not require | Effectiveness | May be used with: |
| succession | fired in rapid | extra drive circuits | depends | IJ01, IJ02, IJ03, |
| of | succession. In | on the print head | substantially upon | IJ04, IJ05, IJ06, |
| actuator | some | Can be readily | the configuration | IJ07, IJ09, IJ10, |
| pulses | configurations, this | controlled and | of the ink jet | IJ11, IJ14, IJ16, |
| | may cause heat | initiated by digital | nozzle | IJ20, IJ22, IJ23, |
| | build-up at the | logic | | IJ24, IJ25, IJ27, |
| | nozzle which boils | | | IJ28, IJ29, IJ30, |
| | the ink, clearing | | | IJ31, IJ32, IJ33, |
| | the nozzle. In other | | | IJ34, IJ36, IJ37, |
| | situations, it may | | | IJ38, IJ39, IJ40, |
| | cause sufficient | | | IJ41, IJ42, IJ43, |
| | vibrations to | | | IJ44, IJ45 |
| | dislodge clogged | | | |
| | nozzles. | | | |
| Extra | Where an actuator | A simple solution | Not suitable where | May be used with: |
| power to | is not normally | where applicable | there is a hard | IJ03, IJ09, IJ16, |
| ink | driven to the limit | | limit to actuator | IJ20, IJ23, IJ24, |
| pushing | of its motion, | | movement | IJ25, IJ27, IJ29, |
| actuator | nozzle clearing | | | IJ30, IJ31, IJ32, |
| | may be assisted by | | | IJ39, IJ40, IJ41, |
| | providing an | | | IJ42, IJ43, IJ44, |
| | enhanced drive | | | IJ45 |
| | signal to the | | | |
| | actuator. | | | |
| Acoustic | An ultrasonic | A high nozzle | High | IJ08, IJ13, IJ15, |
| resonance | wave is applied to | clearing capability | implementation | IJ17, IJ18, IJ19, |
| | the ink chamber. | can be achieved | cost if system does | IJ21 |
| | This wave is of an | May be | not already include | |
| | appropriate | implemented at | an acoustic | |
| | amplitude and | very low cost in | actuator | |
| | frequency to cause | systems which | | |
| | sufficient force at | already include | | |
| | the nozzle to clear | acoustic actuators | | |
| | blockages. This is | | | |
| | easiest to achieve | | | |
| | if the ultrasonic | | | |
| | wave is at a | | | |
| | resonant frequency | | | |
| | of the ink cavity. | | | |
| Nozzle | A microfabricated | Can clear severely | Accurate | Silverbrook, EP |
| clearing | plate is pushed | clogged nozzles | mechanical | 0771 658 A2 and |
| plate | against the | | alignment is | related patent |
| | nozzles. The plate | | required | applications |
| | has a post for | | Moving parts are | |
| | every nozzle. A | | required | |
| | post moves | | There is risk of | |
| | through each | | damage to the | |
| | nozzle, displacing | | nozzles | |
| | dried ink. | | Accurate | |
| | | | fabrication is | |
| | | | required | |
| Ink | The pressure of the | May be effective | Requires pressure | May be used with |
| pressure | ink is temporarily | where other | pump or other | all IJ series ink jets |
| pulse | increased so that | methods cannot be | pressure actuator | |
| | ink streams from | used | Expensive | |
| | all of the nozzles. | | Wasteful of ink | |
| | This may be used | | | |
| | in conjunction | | | |
| | with actuator | | | |
| | energizing. | | | |
| Print head | A flexible ‘blade’ | Effective for | Difficult to use if | Many ink jet |
| wiper | is wiped across the | planar print head | print head surface | systems |
| | print head surface. | surfaces | is non-planar or | |
| | The blade is | Low cost | very fragile | |
| | usually fabricated | | Requires | |
| | from a flexible | | mechanical parts | |
| | polymer, e.g. | | Blade can wear out | |
| | rubber or synthetic | | in high volume | |
| | elastomer. | | print systems | |
| Separate | A separate heater | Can be effective | Fabrication | Can be used with |
| ink boiling | is provided at the | where other nozzle | complexity | many IJ series ink |
| heater | nozzle although | clearing methods | | jets |
| | the normal drop e- | cannot be used | | |
| | ection mechanism | Can be | | |
| | does not require it. | implemented at no | | |
| | The heaters do not | additional cost in | | |
| | require individual | some ink jet | | |
| | drive circuits, as | configurations | | |
| | many nozzles can | | | |
| | be cleared | | | |
| | simultaneously, | | | |
| | and no imaging is | | | |
| | required. | | | |

Nozzle plate construction

| | Description | Advantages | Disadvantages | Examples |
|---|---|---|---|---|
| Electroformed | A nozzle plate is | Fabrication | High temperatures | Hewlett Packard |
| nickel | separately | simplicity | and pressures are | Thermal Ink jet |
| | fabricated from | | required to bond | |
| | electroformed | | nozzle plate | |
| | nickel, and bonded | | Minimum | |
| | to the print head | | thickness | |
| | chip. | | constraints | |
| | | | Differential | |
| | | | thermal expansion | |
| Laser | Individual nozzle | No masks required | Each hole must be | Canon Bubblejet |
| ablated or | holes are ablated | Can be quite fast | individually | 1988 Sercel et al., |
| drilled | by an intense UV | Some control over | formed | SPIE, Vol. 998 |
| polymer | laser in a nozzle | nozzle profile is | Special equipment | Excimer Beam |
| | plate, which is | possible | required | Applications, pp. |
| | typically a | Equipment | Slow where there | 76-83 |
| | polymer such as | required is | are many | 1993 Watanabe et |
| | polyimide or | relatively low cost | thousands of | al., U.S. Pat. No. 5,208,604 |
| | polysulphone | | nozzles per print | |
| | | | head | |
| | | | May produce thin | |
| | | | burrs at exit holes | |
| Silicon | A separate nozzle | High accuracy is | Two part | K. Bean, IEEE |
| micromachined | plate is | attainable | construction | Transactions on |
| | micromachined | | High cost | Electron Devices, |
| | from single crystal | | Requires precision | Vol. ED-25, No. |
| | silicon, and | | alignment | 10, 1978, pp 1185-1195 |
| | bonded to the print | | Nozzles may be | Xerox 1990 |
| | head wafer. | | clogged by | Hawkins et al., |
| | | | adhesive | U.S. Pat. No. 4,899,181 |
| Glass | Fine glass | No expensive | Very small nozzle | 1970 Zoltan U.S. Pat. No. |
| capillaries | capillaries are | equipment | sizes are difficult | 3,683,212 |
| | drawn from glass | required | to form | |
| | tubing. This | Simple to make | Not suited for | |
| | method has been | single nozzles | mass production | |
| | used for making | | | |
| | individual nozzles, | | | |
| | but is difficult to | | | |
| | use for bulk | | | |
| | manufacturing of | | | |
| | print heads with | | | |
| | thousands of | | | |
| | nozzles. | | | |
| Monolithic, | The nozzle plate is | High accuracy (<1 μm) | Requires | Silverbrook, EP |
| surface | deposited as a | Monolithic | sacrificial layer | 0771 658 A2 and |
| micromachined | layer using | Low cost | under the nozzle | related patent |
| using | standard VLSI | Existing processes | plate to form the | applications |
| VLSI | deposition | can be used | nozzle chamber | IJ01, IJ02, IJ04, |
| lithographic | techniques. | | Surface may be | IJ11, IJ12, IJ17, |
| processes | Nozzles are etched | | fragile to the touch | IJ18, IJ20, IJ22, |
| | in the nozzle plate | | | IJ24, IJ27, IJ28, |
| | using VLSI | | | IJ29, IJ30, IJ31, |
| | lithography and | | | IJ32, IJ33, IJ34, |
| | etching. | | | IJ36, IJ37, IJ38, |
| | | | | IJ39, IJ40, IJ41, |
| | | | | IJ42, IJ43, IJ44 |
| Monolithic, | The nozzle plate is | High accuracy (<1 μm) | Requires long etch | IJ03, IJ05, IJ06, |
| etched | a buried etch stop | Monolithic | times | IJ07, IJ08, IJ09, |
| through | in the wafer. | Low cost | Requires a support | IJ10, IJ13, IJ14, |
| substrate | Nozzle chambers | No differential | wafer | IJ15, IJ16, IJ19, |
| | are etched in the | expansion | | IJ21, IJ23, IJ25, |
| | front of the wafer, | | | IJ26 |
| | and the wafer is | | | |
| | thinned from the | | | |
| | back side. Nozzles | | | |
| | are then etched in | | | |
| | the etch stop layer. | | | |
| No nozzle | Various methods | No nozzles to | Difficult to control | Ricoh 1995 Sekiya |
| plate | have been tried to | become clogged | drop position | et al U.S. Pat. No. |
| | eliminate the | | accurately | 5,412,413 |
| | nozzles entirely, to | | Crosstalk | 1993 Hadimioglu |
| | prevent nozzle | | problems | et al EUP 550,192 |
| | clogging. These | | | 1993 Elrod et al |
| | include thermal | | | EUP 572,220 |
| | bubble | | | |
| | mechanisms and | | | |
| | acoustic lens | | | |
| | mechanisms | | | |
| Trough | Each drop ejector | Reduced | Drop firing | IJ35 |
| | has a trough | manufacturing | direction is | |
| | through which a | complexity | sensitive to | |
| | paddle moves. | Monolithic | wicking. | |
| | There is no nozzle | | | |
| | plate. | | | |
| Nozzle slit | The elimination of | No nozzles to | Difficult to control | 1989 Saito et al |
| instead of | nozzle holes and | become clogged | drop position | U.S. Pat. No. 4,799,068 |
| individual | replacement by a | | accurately | |
| nozzles | slit encompassing | | Crosstalk | |
| | many actuator | | problems | |
| | positions reduces | | | |
| | nozzle clogging, | | | |
| | but increases | | | |
| | crosstalk due to | | | |
| | ink surface waves | | | |

Drop ejection direction

| | Description | Advantages | Disadvantages | Examples |
|---|---|---|---|---|
| Edge | Ink flow is along | Simple | Nozzles limited to | Canon Bubblejet |
| (‘edge | the surface of the | construction | edge | 1979 Endo et al |
| shooter’) | chip, and ink drops | No silicon etching | High resolution is | GB patent |
| | are ejected from | required | difficult | 2,007,162 |
| | the chip edge. | Good heat sinking | Fast color printing | Xerox heater-in-pit |
| | | via substrate | requires one print | 1990 Hawkins et |
| | | Mechanically | head per color | al U.S. Pat. No. 4,899,181 |
| | | strong | | Tone-jet |
| | | Ease of chip | | |
| | | handing | | |
| Surface | Ink flow is along | No bulk silicon | Maximum ink | Hewlett-Packard |
| (‘roof | the surface of the | etching required | flow is severely | TIJ 1982 Vaught |
| shooter’) | chip, and ink drops | Silicon can make | restricted | et al U.S. Pat. No. |
| | are ejected from | an effective heat | | 4,490,728 |
| | the chip surface, | sink | | IJ02, IJ11, IJ12, |
| | normal to the | Mechanical | | IJ20, IJ22 |
| | plane of the chip. | strength | | |
| Through | Ink flow is through | High ink flow | Requires bulk | Silverbrook, EP |
| chip, | the chip, and ink | Suitable for | silicon etching | 0771 658 A2 and |
| forward | drops are ejected | pagewidth print | | related patent |
| (‘up | from the front | heads | | applications |
| shooter’) | surface of the chip. | High nozzle | | IJ04, IJ17, IJ18, |
| | | packing density | | IJ24, IJ27-IJ45 |
| | | therefore low | | |
| | | manufacturing cost | | |
| Through | Ink flow is through | High ink flow | Requires wafer | IJ01, IJ03, IJ05, |
| chip, | the chip, and ink | Suitable for | thinning | IJ06, IJ07, IJ08, |
| reverse | drops are ejected | pagewidth print | Requires special | IJ09, IJ10, IJ13, |
| (‘down | from the rear | heads | handling during | IJ14, IJ15, IJ16, |
| shooter’) | surface of the chip. | High nozzle | manufacture | IJ19, IJ21, IJ23, |
| | | packing density | | IJ25, IJ26 |
| | | therefore low | | |
| | | manufacturing cost | | |
| Through | Ink flow is through | Suitable for | Pagewidth print | Epson Stylus |
| actuator | the actuator, which | piezoelectric print | heads require | Tektronix hot melt |
| | is not fabricated as | heads | several thousand | piezoelectric ink |
| | part of the same | | connections to | jets |
| | substrate as the | | drive circuits | |
| | drive transistors. | | Cannot be | |
| | | | manufactured in | |
| | | | standard CMOS | |
| | | | fabs | |
| | | | Complex assembly | |
| | | | required | |

Ink type

| | Description | Advantages | Disadvantages | Examples |
|---|---|---|---|---|
| Aqueous, | Water based ink | Environmentally | Slow drying | Most existing ink |
| dye | which typically | friendly | Corrosive | jets |
| | contains: water, | No odor | Bleeds on paper | All IJ series ink |
| | dye, surfactant, | | May strikethrough | jets |
| | humectant, and | | Cockles paper | Silverbrook, EP |
| | biocide. | | | 0771 658 A2 and |
| | Modern ink dyes | | | related patent |
| | have high water- | | | applications |
| | fastness, light | | | |
| | fastness | | | |
| Aqueous, | Water based ink | Environmentally | Slow drying | IJ02, IJ04, IJ21, |
| pigment | which typically | friendly | Corrosive | IJ26, IJ27, IJ30 |
| | contains: water, | No odor | Pigment may clog | Silverbrook, EP |
| | pigment, | Reduced bleed | nozzles | 0771 658 A2 and |
| | surfactant, | Reduced wicking | Pigment may clog | related patent |
| | humectant, and | Reduced | actuator | applications |
| | biocide. | strikethrough | mechanisms | Piezoelectric ink- |
| | Pigments have an | | Cockles paper | jets |
| | advantage in | | | Thermal ink jets |
| | reduced bleed, | | | (with significant |
| | wicking and | | | restrictions) |
| | strikethrough. | | | |
| Methyl | MEK is a highly | Very fast drying | Odorous | All IJ series ink |
| Ethyl | volatile solvent | Prints on various | Flammable | jets |
| Ketone | used for industrial | substrates such as | | |
| (MEK) | printing on | metals and plastics | | |
| | difficult surfaces | | | |
| | such as aluminum | | | |
| | cans. | | | |
| Alcohol | Alcohol based inks | Fast drying | Slight odor | All IJ series ink |
| (ethanol, | can be used where | Operates at sub- | Flammable | jets |
| 2-butanol, | the printer must | freezing | | |
| and | operate at | temperatures | | |
| others) | temperatures | Reduced paper | | |
| | below the freezing | cockle | | |
| | point of water. An | Low cost | | |
| | example of this is | | | |
| | in-camera | | | |
| | consumer | | | |
| | photographic | | | |
| | printing. | | | |
| Phase | The ink is solid at | No drying time- | High viscosity | Tektronix hot melt |
| change | room temperature, | ink instantly | Printed ink | piezoelectric ink |
| (hot melt) | and is melted in | freezes on the print | typically has a | jets |
| | the print head | medium | ‘waxy’ feel | 1989 Nowak U.S. Pat. No. |
| | before jetting. Hot | Almost any print | Printed pages may | 4,820,346 |
| | melt inks are | medium can be | ‘block’ | All IJ series ink |
| | usually wax based, | used | Ink temperature | jets |
| | with a melting | No paper cockle | may be above the | |
| | point around 80° C. | occurs | curie point of | |
| | After jetting | No wicking occurs | permanent | |
| | the ink freezes | No bleed occurs | magnets | |
| | almost instantly | No strikethrough | Ink heaters | |
| | upon contacting | occurs | consume power | |
| | the print medium | | Long warm-up | |
| | or a transfer roller. | | time | |
| Oil | Oil based inks are | High solubility | High viscosity: | All IJ series ink |
| | extensively used in | medium for some | this is a significant | jets |
| | offset printing. | dyes | limitation for use | |
| | They have | Does not cockle | in ink jets, which | |
| | advantages in | paper | usually require a | |
| | improved | Does not wick | low viscosity. | |
| | characteristics on | through paper | Some short chain | |
| | paper (especially | | and multi- | |
| | no wicking or | | branched oils have | |
| | cockle). Oil | | a sufficiently low | |
| | soluble dies and | | viscosity. | |
| | pigments are | | Slow drying | |
| | required. | | | |
| Microemulsion | A microemulsion | Stops ink bleed | Viscosity higher | All IJ series ink |
| | is a stable, self | High dye solubility | than water | jets |
| | forming emulsion | Water, oil, and | Cost is slightly | |
| | of oil, water, and | amphiphilic | higher than water | |
| | surfactant. The | soluble dies can be | based ink | |
| | characteristic drop | used | High surfactant | |
| | size is less than | Can stabilize | concentration | |
| | 100 nm, and is | pigment | required (around | |
| | determined by the | suspensions | 5%) | |
| | preferred curvature | | | |
| | of the surfactant. | | | |

1. A printhead comprising a plurality of unit cells, at least one of the plurality of unit cells comprising:
a substrate including an ink inlet passage;
a chamber defined by chamber sidewalls and at least part of a nozzle plate defining an aperture for ejection of ink from the chamber, the chamber being in fluid communication with the inlet passage; and,
a nozzle enclosure comprising enclosure sidewalls and a roof defining an opening for ejection of ink, the nozzle enclosure surrounding the aperture such that ink ejected from the aperture is directed to the opening of the nozzle enclosure, thereby isolating the aperture from an adjacent aperture of an adjacent unit cell.

2. The printhead of claim 1, wherein the enclosure sidewalls abut or are integrally formed with the at least part of the nozzle plate.

3. The printhead of claim 1, including a plurality of formations about the aperture, the formations assisting to isolate the aperture from the adjacent aperture.

4. The printhead of claim 3, wherein the nozzle enclosure also surrounds the formations.

5. The printhead of claim 3, wherein the formations each have a hydrophobic surface.

6. The printhead of claim 3, wherein the formations include at least a rim about the aperture.

7. The printhead of claim 1, wherein the opening has a greater diameter than the aperture.

8. The printhead of claim 1, wherein the roof is spaced apart from the at least part of the nozzle plate.

9. The printhead of claim 1, wherein the roof opening is spaced apart from and aligned with the nozzle aperture, thereby allowing ejected ink droplets to pass therethrough onto the print medium.

10. The printhead of claim 1, wherein the enclosure sidewalls extend from a perimeter region of the roof.

11. The printhead of claim 1, wherein the chamber includes a heater element.

12. The printhead of claim 1, which is a pagewidth inkjet printhead.

13. The printhead of claim 1, wherein the printhead has a nozzle density sufficient to print at up to 1600 dpi.

14. A printer comprising the printhead according to claim 1.
